(19) United States
(12) Patent Application Publication
(10) Pub. No.: US 2019/0108174 A1
(43) Pub. Date: Apr. 11, 2019

(54) Data Table Processing Method and Apparatus

(71) Applicant: Huawei Technologies Co., Ltd., Shenzhen (CN)

(72) Inventors: Peiliang Du, Shenzhen (CN); Chuanting Wang, Beijing (CN); Lin Huang, Beijing (CN)

(21) Appl. No.: 16/204,526

(22) Filed: Nov. 29, 2018

Related U.S. Application Data
(63) Continuation of application No. PCT/CN2017/075998, filed on Mar. 8, 2017.

(30) Foreign Application Priority Data
May 31, 2016 (CN) 201610379416.8

(51) Int. Cl. G06F 16/2455; G06F 16/22

(52) U.S. Cl. CPC G06F 16/24553; G06F 16/2282; G06F 16/221

(57) ABSTRACT

A data system comprising a primary server and a secondary server, where the primary server obtains a first partition instruction and a second partition instruction, partition data in a first data table according to a first partition key to obtain a first partition table, and send the second partition instruction to the secondary server. The first partition instruction includes a first partition key, and the second partition instruction includes a second partition key, which is different from the first partition key. The second partition instruction is for triggering the secondary server to partition data in a second data table on the secondary server according to the second partition key to obtain a second partition table, which is the same as the first data table.

### CROSS-REFERENCE TO RELATED APPLICATIONS

This application is a continuation of International Patent Application No. PCT/CN2017/075998 filed on Mar. 8, 2017, which claims priority to Chinese Patent Application No. 201610379416.8 filed on May 31, 2016. The disclosures of the aforementioned applications are hereby incorporated by reference in their entireties.

### TECHNICAL FIELD

This application relates to the field of computer technologies, and in particular, to a data table processing method, an apparatus, and a system.

### BACKGROUND

A partition technology is a technology usually used in a database system. The technology means that rows or columns in a data table that meet different conditions are grouped into different areas according to a partition key, that is, data in the data table is partitioned into multiple smaller data areas with a commonality. These data areas logically belong to one tablespace (that is, one data table), but are physically data independent of each other. A data table obtained by means of partition may be referred to as a partition table. During a query in the partition table, to improve query efficiency, a partition pruning technology is usually used, that is, a required partition is obtained by means of screening according to a condition corresponding to a query column. When the partition pruning technology is used, a query column specified by a where sub-statement in a query instruction needs to be a partition key (which is used to indicate an attribute of partial data, for example, a header of one or more columns in the data table, or a header of one or more rows in the data table). Therefore, if the partition pruning technology is used, it needs to be ensured that a partition key in a to-be-queried partition table is the same as the query column.

Currently, after a physical machine creates a data table, the physical machine may partition data in the data table according to different partition keys in order to obtain different partition tables. In this way, when the data in the data table needs to be queried using the partition pruning technology, the physical machine may directly perform a query in a corresponding partition table in order to improve query efficiency.

However, as technologies develop, a growing amount of data needs to be maintained in a current database system. In many application scenarios (for example, cloud computing and big data), a large amount of data needs to be maintained, and the physical machine also stores an increasing quantity of partition tables. Due to an existing partition table creation manner and management manner, many partition tables having same content need to be maintained in the database system, redundancy is relatively large, and storage space of the physical machine is wasted. Consequently, data processing performance is affected.

### SUMMARY

Embodiments of the present disclosure provide a data table processing method, an apparatus, and a system such that storage space of a physical machine in a database system cluster can be saved, and data processing performance is improved.

To achieve the foregoing objective, the following technical solutions are used in the embodiments of the present disclosure.

According to a first aspect, an embodiment of the present disclosure provides a data table processing method, where the processing method is applied to a primary server in a database system cluster, the database system cluster includes the primary server and a secondary server, and the processing method includes obtaining, by the primary server, a first partition instruction and a second partition instruction, where the first partition instruction includes a first partition key, and the second partition instruction includes a second partition key different from the first partition key, partitioning, by the primary server, data in a first data table on the primary server according to the first partition key in order to obtain a first partition table, and sending, by the primary server, the second partition instruction to the secondary server, where the second partition instruction is used to trigger the secondary server to partition, according to the second partition key, data in a second data table that is on the secondary server and is the same as the first data table in order to obtain a second partition table.

The first data table may include data of multiple services, and data of each service may be understood as one column of data in the first data table, that is, each service may be understood as a header of one column in the first data table. In this way, the first partition key may be understood as one of the multiple services, that is, the first partition key may be understood as a header of one column in the first data table. The first partition table is a partition table corresponding to the service. The second data table, the second partition key, and the second partition table are respectively similar to the first data table, the first partition key, and the first partition table. Details are not described herein.

In the data table processing method provided in this embodiment of the present disclosure, the first data table on the primary server may be partitioned on the primary server according to the first partition key in order to obtain the first partition table. The second data table that is on the secondary server and is the same as the first data table is partitioned on the secondary server according to the second partition key different from the first partition key in order to obtain the second partition table. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

Optionally, in this embodiment of the present disclosure, the processing method further includes obtaining, by the primary server, a first creation instruction used to create the first data table and a second creation instruction used to create the second data table, creating, by the primary server, the first data table on the primary server according to the first creation instruction, and sending, by the primary server, the second creation instruction to the secondary server in order to trigger the secondary server to create the second data table on the secondary server.

Optionally, in this embodiment of the present disclosure, the first creation instruction, the second creation instruction, the first partition instruction, and the second partition instruction may be all included in one instruction set.

Optionally, in a first possible implementation, the processing method further includes obtaining, by the primary server, a query instruction that includes a query column and a query condition, where the query column is the same as the first partition key, and the query instruction is used to query data that is in the first partition table and that meets the query condition, and executing, by the primary server, the query instruction on the first partition table.

Optionally, in a second possible implementation, the processing method further includes obtaining, by the primary server, a query instruction that includes a query column and a query condition, where the query column is the same as the second partition key, and the query instruction is used to query data that is in the second partition table and that meets the query condition, and sending, by the primary server, the query instruction to the secondary server such that the secondary server executes the query instruction on the second partition table.

In this embodiment of the present disclosure, the first data table on the primary server is partitioned according to the first partition key, and the second data table on the secondary server is partitioned according to the second partition key. When data of a service in a data table needs to be queried, if the primary server determines that the query column in the query instruction is the same as the first partition key, the primary server executes the query instruction on the first partition table, that is, queries the data that is in the first partition table on the primary server and that meets the query condition, if the primary server determines that the query column is different from both the first partition key and the second partition key, the primary server executes the query instruction on the first partition table, that is, queries the data that is in the first partition table on the primary server and that meets the query condition, or if the primary server determines that the query column is the same as the second partition key, the primary server sends the query instruction to the secondary server such that the secondary server executes the query instruction on the second partition table, that is, queries the data that is in the second partition table on the secondary server and that meets the query condition.

In this embodiment of the present disclosure, to improve query efficiency during a query of data of a service, a partition pruning technology may be used in a query process. The partition pruning technology is a process in which an unnecessary partition is removed and a required partition is extracted, according to a from partition table in a query statement and a condition (that is, a query condition) corresponding to a query column in a where sub-statement. For example, if a data table is T1, T1 is partitioned according to c1, and a condition corresponding to a query column is c1<200, using the partition pruning technology, a partition different from a partition meeting c1<200 may be removed from T1, and the partition meeting c1<200 is extracted, which is data that is in T1 and that meets the query condition.

Optionally, in a third possible implementation, the processing method further includes obtaining, by the primary server, a query instruction that includes a first query column, a first query condition corresponding to the first query column, a second query column, and a second query condition corresponding to the second query column, where the first query column is the same as the first partition key, the second query column is the same as the second partition key, an “and” relationship exists between the first query condition and the second query condition, and the query instruction is used to query data that is in the first partition table and that meets the first query condition and the second query condition, and executing, by the primary server, the query instruction on the first partition table.

Optionally, in a fourth possible implementation, the processing method further includes obtaining, by the primary server, a query instruction that includes a first query column, a first query condition corresponding to the first query column, a second query column, and a second query condition corresponding to the second query column, where the first query column is the same as the first partition key, the second query column is the same as the second partition key, an “or” relationship exists between the first query condition and the second query condition, and the query instruction is used to query data that is in the first partition table and that meets the first query condition, and query data that is in the second partition table and that meets the second query condition, splitting, by the primary server, the query instruction into a first query instruction that includes the first query column and the first query condition and a second query instruction that includes the second query column and the second query condition, executing, by the primary server, the first query instruction on the first partition table, and sending, by the primary server, the second query instruction to the secondary server such that the secondary server executes the second query instruction on the second partition table.

In this embodiment of the present disclosure, when a query instruction includes two query columns and two query conditions (which may also be multiple query columns and multiple query conditions in actual use), the primary server may determine, according to a relationship between the two query conditions, a specific physical machine (the primary server or the secondary server) for executing the query instruction. Therefore, based on a partition table obtained using the data table processing method provided in this embodiment of the present disclosure, query efficiency during a query of the partition table can be improved to some extent.

Optionally, in this embodiment of the present disclosure, the processing method further includes obtaining, by the primary server, a modification instruction, modifying, by the primary server, the first partition table according to the modification instruction, and sending, by the primary server, the modification instruction to the secondary server in order to trigger the secondary server to modify the second partition table.

In this embodiment of the present disclosure, compared with a method in which the primary server and the secondary server synchronize their respective partition tables with each other using a physical log (that synchronization is performed using the physical log may be understood as follows. The primary server sends modified data to the secondary server, and the secondary server updates the data), in the method in which the primary server and the secondary server synchronize their respective partition tables with each other using a logical log, the primary server directly sends the modification instruction (overheads of the modification instruction are much fewer than overheads of data) to the secondary server such that the secondary server modifies the partition table of the secondary server by executing the modification instruction. Therefore, synchronization overheads for synchronizing the first partition table on the primary server with the second partition table on the secondary server can be reduced.

According to a second aspect, an embodiment of the present disclosure provides a data table processing method, where the processing method is applied to a secondary server in a database system cluster, the database system cluster includes a primary server and the secondary server, and the processing method includes receiving, by the secondary server, a partition instruction that is sent by the primary server and includes a partition key, and partitioning, by the secondary server, data in a second data table on the secondary server according to the partition instruction in order to obtain a partition table, where the second data table is the same as a first data table on the primary server, and the first data table is partitioned according to a partition key different from the partition key. The partition key by which the primary server partitions the first data table is referred to as a first partition key, and a partition table obtained after the primary server partitions the first data table is referred to as a first partition table. The partition key by which the secondary server partitions the second data table is referred to as a second partition key, and the partition table obtained after the secondary server partitions the second data table is referred to as a second partition table.

In the data table processing method provided in this embodiment of the present disclosure, the second data table that is the same as the first data table on the primary server may be partitioned on the secondary server according to the second partition key different from the first partition key for partitioning the first data table on the primary server in order to obtain the second partition table different from the first partition table on the primary server. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

Optionally, in this embodiment of the present disclosure, the processing method further includes receiving, by the secondary server, a query instruction that is sent by the primary server and includes a query column and a query condition, where the query column is the same as the partition key, and the query instruction is used to query data that is in the partition table (that is, the second partition table) on the secondary server and that meets the query condition, and executing, by the secondary server, the query instruction on the partition table on the secondary server.

In this embodiment of the present disclosure, based on a partition table obtained using the data table processing method provided in this embodiment of the present disclosure, a corresponding query instruction may be executed by a different physical machine (the primary server or the secondary server). For example, the secondary server executes the query instruction that includes the query column the same as the second partition key such that query efficiency can be improved to some extent.

Optionally, in this embodiment of the present disclosure, the processing method further includes receiving, by the secondary server, a modification instruction sent by the primary server, and modifying, by the secondary server, the partition table on the secondary server according to the modification instruction.

In this embodiment of the present disclosure, when the primary server receives the modification instruction for the partition table on the primary server, the primary server may send the modification instruction to the secondary server using a synchronization method with a logical log such that the secondary server modifies the partition table on the secondary server according to the modification instruction. In this way, synchronization overheads for synchronizing the partition table on the primary server with the partition table on the secondary server can be reduced.

According to a third aspect, an embodiment of the present disclosure provides a data table processing method, where the processing method is applied to a primary server in a database system cluster, the database system cluster includes the primary server and a secondary server, and the processing method includes obtaining, by the primary server, a query instruction that includes a first query column and a first query condition corresponding to the first query column, where the query instruction is used to query data that is in a partition table and that meets the first query condition, executing, by the primary server, the query instruction on the first partition table when the first query column is the same as a first partition key in a first partition table, where the first partition table is obtained by partitioning data in a first data table on the primary server according to the first partition key, or sending, by the primary server, the query instruction to the secondary server when the first query column is the same as a second partition key in a second partition table such that the secondary server executes the query instruction on the second partition table, where the second partition table is obtained by partitioning data in a second data table on the secondary server according to the second partition key, the second data table is the same as a first data table, and the second partition key is different from a first partition key.

In the data table processing method provided in this embodiment of the present disclosure, the first partition table is obtained by partitioning the data in the first data table on the primary server according to the first partition key, and the second partition table is obtained by partitioning, according to the second partition key, the data in the second data table that is on the secondary server and is the same as the first data table. Therefore, when the first query column in the query instruction obtained by the primary server is the same as the first partition key, the primary server may execute the query instruction on the first partition table, or when the first query column in the query instruction obtained by the primary server is the same as the second partition key, the primary server may send the query instruction to the secondary server such that the secondary server executes the query instruction on the second partition table. A same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

Optionally, in a first possible implementation, when the first query column is the same as the first partition key in the first partition table, the query instruction further includes a second query column and a second query condition, where the second query column is the same as the second partition key in the second partition table, an “and” relationship exists between the first query condition and the second query condition, the query instruction is further used to query data that is in the first partition table and that meets the second query condition, the second partition table is obtained by partitioning the data in the second data table on the secondary server according to the second partition key, the second data table is the same as the first data table, and the second partition key is different from the first partition key.

Optionally, in a second possible implementation, when the first query column is the same as the first partition key in the first partition table, the query instruction further includes a second query column and a second query condition, where the second query column is the same as the second partition key in the second partition table, an “or” relationship exists between the first query condition and the second query condition, and the query instruction is further used to query data that is in the second partition table and that meets the second query condition. The processing method further includes splitting, by the primary server, the query instruction into a first query instruction that includes the first query column and the first query condition and a second query instruction that includes the second query column and the second query condition, where the second partition table is obtained by partitioning the data in the second data table on the secondary server according to the second partition key, the second data table is the same as the first data table, and the second partition key is different from the first partition key, and sending, by the primary server, the second query instruction to the secondary server such that the secondary server executes the second query instruction on the second partition table.

A method in which the primary server executes the query instruction on the first partition table includes executing, by the primary server, the first query instruction on the first partition table.

In this embodiment of the present disclosure, when a query instruction includes two query columns and two query conditions (which may also be multiple query columns and multiple query conditions in actual use), the primary server may determine, according to a relationship between the two query conditions, a specific physical machine (the primary server or the secondary server) for executing the query instruction. Therefore, based on a partition table obtained using the data table processing method provided in this embodiment of the present disclosure, query efficiency during a query of the partition table can be improved to some extent.

According to a fourth aspect, an embodiment of the present disclosure provides a data table processing method, where the processing method is applied to a secondary server in a database system cluster, the database system cluster includes a primary server and the secondary server, and the processing method includes receiving, by the secondary server, a query instruction that is sent by the primary server and includes a query column and a query condition, where the query column is the same as a partition key in a partition table, the query instruction is used to query data that is in the partition table and that meets the query condition, the partition table is obtained by partitioning data in a second data table on the secondary server according to the partition key, and the second data table is the same as a first data table on the primary server, and executing, by the secondary server, the query instruction on the partition table.

In the data table processing method provided in this embodiment of the present disclosure, the partition table is obtained by partitioning, according to the partition key, the data in the second data table that is on the secondary server and is the same as the first data table on the primary server. Therefore, when a query column in a query instruction obtained by the primary server is the same as the partition key, the primary server sends the query instruction to the secondary server such that the secondary server executes the query instruction on the partition table. Compared with the other approaches, in the data table processing method provided in this embodiment of the present disclosure, because the secondary server does not need to store multiple partition tables the same as partition tables stored in the primary server, a quantity of partition tables stored in the secondary server may be reduced such that storage space of the secondary server in the database system cluster can be saved, and data processing performance is improved, that is, data can be better managed.

According to a fifth aspect, an embodiment of the present disclosure provides a physical machine, where the physical machine is a primary server in a database system cluster, the database system cluster includes the primary server and a secondary server, and the primary server includes an obtaining unit, an execution unit, and a sending unit.

The obtaining unit is configured to obtain a first partition instruction that includes a first partition key and a second partition instruction that includes a second partition key, where the second partition key is different from the first partition key. The execution unit is configured to partition data in a first data table on the primary server according to the first partition instruction in order to obtain a first partition table. The sending unit is configured to send the second partition instruction obtained by the obtaining unit to the secondary server, where the second partition instruction is used to trigger the secondary server to partition, according to the second partition key, data in a second data table that is on the secondary server and is the same as the first data table in order to obtain a second partition table.

The physical machine provided in this embodiment of the present disclosure is the primary server in the database system cluster. The first data table on the primary server may be partitioned on the primary server according to the first partition key in order to obtain the first partition table. The second data table that is on the secondary server and is the same as the first data table is partitioned on the secondary server according to the second partition key different from the first partition key in order to obtain the second partition table. That is, a same data table may be partitioned on the primary server and the secondary server according to different partition keys in order to obtain different partition tables. Therefore, compared with the other approaches, according to the physical machine provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

It should be noted that the physical machine provided in this embodiment of the present disclosure includes but is not limited to the obtaining unit, the execution unit, and the sending unit in the fifth aspect, and functions of the obtaining unit, the execution unit, and the sending unit in the fifth aspect include but are not limited to the foregoing functions. The physical machine may include units/modules configured to execute the data table processing method according to the first aspect or the optional manners of the first aspect. The units/modules represent logical division of the physical machine for a purpose of executing the data table processing method according to the first aspect or the optional manners of the first aspect.

For detailed descriptions of technical effects in optional manners of the fifth aspect, refer to the related descriptions of technical effects in the corresponding optional manners of the first aspect. Details are not described herein.

According to a sixth aspect, an embodiment of the present disclosure provides a physical machine, where the physical machine is a secondary server in a database system cluster, the database system cluster includes a primary server and the secondary server, and the secondary server includes a receiving unit and an execution unit.

The receiving unit is configured to receive a partition instruction that is sent by the primary server and includes a partition key. The execution unit is configured to partition data in a second data table on the secondary server according to the partition instruction received by the receiving unit and the partition key in order to obtain a partition table, where the second data table is the same as a first data table on the primary server, and the first data table is partitioned according to a partition key different from the partition key. The partition key by which the primary server partitions the first data table is referred to as a first partition key, and a partition table obtained after the primary server partitions the first data table is referred to as a first partition table. The partition key by which the secondary server partitions the second data table is referred to as a second partition key, and the partition table obtained after the secondary server partitions the second data table is referred to as a second partition table.

The physical machine provided in this embodiment of the present disclosure is the secondary server in the database system cluster. The second data table that is the same as the first data table on the primary server may be partitioned on the secondary server according to the second partition key different from the first partition key for partitioning the first data table on the primary server in order to obtain the second partition table different from the first partition table on the primary server. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

It should be noted that the physical machine provided in this embodiment of the present disclosure includes but is not limited to the receiving unit and the execution unit in the sixth aspect, and functions of the receiving unit and the execution unit in the sixth aspect include but are not limited to the foregoing functions. The physical machine may include units/modules configured to execute the data table processing method according to the second aspect or the optional manners of the second aspect. The units/modules represent logical division of the physical machine for a purpose of executing the data table processing method according to the second aspect or the optional manners of the second aspect.

For detailed descriptions of technical effects in optional manners of the sixth aspect, refer to the related descriptions of technical effects in the corresponding optional manners of the second aspect. Details are not described herein.

According to a seventh aspect, an embodiment of the present disclosure provides a physical machine, where the physical machine is a primary server in a database system cluster, the database system cluster includes the primary server and a secondary server, and the primary server includes an obtaining unit, an execution unit, and a sending unit.

The obtaining unit is configured to obtain a query instruction that includes a first query column and a first query condition corresponding to the first query column, where the query instruction is used to query data that is in a partition table and that meets the first query condition. The execution unit is configured to execute the query instruction obtained by the obtaining unit on the first partition table when the first query column is the same as a first partition key in a first partition table, where the first partition table is obtained by partitioning data in a first data table on the primary server according to the first partition key. The sending unit is configured to send the query instruction obtained by the obtaining unit to the secondary server when the first query column is the same as a second partition key in a second partition table such that the secondary server executes the query instruction on the second partition table, where the second partition table is obtained by partitioning data in a second data table on the secondary server according to the second partition key, the second data table is the same as the first data table, and the second partition key is different from the first partition key.

The physical machine provided in this embodiment of the present disclosure is the primary server in the database system cluster. The first partition table is obtained by partitioning the data in the first data table on the primary server according to the first partition key, and the second partition table is obtained by partitioning, according to the second partition key, the data in the second data table that is on the secondary server and is the same as the first data table. Therefore, when the first query column in the query instruction obtained by the primary server is the same as the first partition key, the primary server may execute the query instruction on the first partition table, or when the first query column in the query instruction obtained by the primary server is the same as the second partition key, the primary server may send the query instruction to the secondary server such that the secondary server executes the query instruction on the second partition table. A same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

It should be noted that the physical machine provided in this embodiment of the present disclosure includes but is not limited to the obtaining unit, the execution unit, and the sending unit in the seventh aspect, and functions of the obtaining unit and the execution unit in the seventh aspect include but are not limited to the foregoing functions. The physical machine may include units/modules configured to execute the data table processing method according to the third aspect or the optional manners of the third aspect. The units/modules represent logical division of the physical machine for a purpose of executing the data table processing method according to the third aspect or the optional manners of the third aspect.

For detailed descriptions of technical effects in optional manners of the seventh aspect, refer to the related descriptions of technical effects in the corresponding optional manners of the third aspect. Details are not described herein.

According to an eighth aspect, an embodiment of the present disclosure provides a physical machine, where the physical machine is a secondary server in a database system cluster, the database system cluster includes a primary server and the secondary server, and the secondary server includes a receiving unit and an execution unit.

The receiving unit is configured to receive a query instruction that is sent by the primary server and includes a query column and a query condition, where the query column is the same as a partition key in a partition table, the query instruction is used to query data that is in the partition table and that meets the query condition, the partition table is obtained by partitioning data in a second data table on the secondary server according to the partition key, and the second data table is the same as a first data table on the primary server. The execution unit is configured to execute the query instruction received by the receiving unit on the partition table.

The physical machine provided in this embodiment of the present disclosure is the secondary server in the database system cluster. The partition table is obtained by partitioning, according to the partition key, the data in the second data table that is on the secondary server and is the same as the first data table on the primary server. Therefore, when a query column in a query instruction obtained by the primary server is the same as the partition key, the primary server sends the query instruction to the secondary server such that the secondary server executes the query instruction on the partition table. Compared with the other approaches, in the data table processing method provided in this embodiment of the present disclosure, because the secondary server does not need to store multiple partition tables the same as partition tables stored in the primary server, a quantity of partition tables stored in the secondary server may be reduced such that storage space of the secondary server in the database system cluster can be saved, and data processing performance is improved, that is, data can be better managed.

It should be noted that the physical machine provided in this embodiment of the present disclosure includes but is not limited to the receiving unit and the execution unit in the eighth aspect, and functions of the receiving unit and the execution unit in the eighth aspect include but are not limited to the foregoing functions. The physical machine may include units/modules configured to execute the data table processing method according to the fourth aspect or the optional manners of the fourth aspect. The units/modules represent logical division of the physical machine for a purpose of executing the data table processing method according to the fourth aspect or the optional manners of the fourth aspect.

According to a ninth aspect, an embodiment of the present disclosure provides a physical machine, where the physical machine is a primary server in a database system cluster, the database system cluster includes the primary server and a secondary server, and the primary server includes a processor, an interface circuit, a storage, and a system bus.

The storage is configured to store a computer execution instruction, the processor, the interface circuit, and the storage are connected to each other using the system bus, and when the primary server runs, the processor executes the computer execution instruction stored in the storage such that the primary server executes the data table processing method according to the first aspect or any one of the optional manners of the first aspect.

According to a tenth aspect, an embodiment of the present disclosure provides a readable storage medium, where the readable storage medium includes a computer execution instruction, and when a primary server runs, a processor of the primary server executes the computer execution instruction such that the primary server executes the data table processing method according to the first aspect or any one of the optional manners of the first aspect.

For detailed descriptions of technical effects in the ninth aspect and the tenth aspect, refer to the related descriptions of technical effects in the first aspect and the optional manners of the first aspect. Details are not described herein.

According to an eleventh aspect, an embodiment of the present disclosure provides a physical machine, where the physical machine is a secondary server in a database system cluster, the database system cluster includes a primary server and the secondary server, and the secondary server includes a processor, an interface circuit, a storage, and a system bus.

The storage is configured to store a computer execution instruction, the processor, the interface circuit, and the storage are connected to each other using the system bus, and when the secondary server runs, the processor executes the computer execution instruction stored in the storage such that the secondary server executes the data table processing method according to the second aspect or any one of the optional manners of the second aspect.

According to a twelfth aspect, an embodiment of the present disclosure provides a readable storage medium, where the readable storage medium includes a computer execution instruction, and when a secondary server runs, a processor of the secondary server executes the computer execution instruction such that the secondary server executes the data table processing method according to the second aspect or any one of the optional manners of the second aspect.

For detailed descriptions of technical effects in the eleventh aspect and the twelfth aspect, refer to the related descriptions of technical effects in the second aspect and the optional manners of the second aspect. Details are not described herein.

According to a thirteenth aspect, an embodiment of the present disclosure provides a physical machine, where the physical machine is a primary server in a database system cluster, the database system cluster includes the primary server and a secondary server, and the primary server includes a processor, an interface circuit, a storage, and a system bus.

The storage is configured to store a computer execution instruction, the processor, the interface circuit, and the storage are connected to each other using the system bus, and when the primary server runs, the processor executes the computer execution instruction stored in the storage such that the primary server executes the data table processing method according to the third aspect or any one of the optional manners of the third aspect.

According to a fourteenth aspect, an embodiment of the present disclosure provides a readable storage medium, where the readable storage medium includes a computer execution instruction, and when a primary server runs, a processor of the primary server executes the computer execution instruction such that the primary server executes the data table processing method according to the third aspect or any one of the optional manners of the third aspect.

For detailed descriptions of technical effects in the thirteenth aspect and the fourteenth aspect, refer to the related descriptions of technical effects in the third aspect and the optional manners of the third aspect. Details are not described herein.

According to a fifteenth aspect, an embodiment of the present disclosure provides a physical machine, where the physical machine is a secondary server in a database system cluster, the database system cluster includes a primary server and the secondary server, and the secondary server includes a processor, an interface circuit, a storage, and a system bus.

The storage is configured to store a computer execution instruction, the processor, the interface circuit, and the storage are connected to each other using the system bus, and when the secondary server runs, the processor executes the computer execution instruction stored in the storage such that the secondary server executes the data table processing method according to the fourth aspect.

According to a sixteenth aspect, an embodiment of the present disclosure provides a readable storage medium, where the readable storage medium includes a computer execution instruction, and when a secondary server runs, a processor of the secondary server executes the computer execution instruction such that the secondary server executes the data table processing method according to the fourth aspect.

For detailed descriptions of technical effects in the fifteenth aspect and the sixteenth aspect, refer to the related descriptions of technical effects in the fourth aspect. Details are not described herein.

According to a seventeenth aspect, an embodiment of the present disclosure provides a database system cluster, where the database system cluster includes a primary server and at least one secondary server.

The primary server is the physical machine according to the fifth aspect, and the secondary server is the physical machine according to the sixth aspect. Alternatively, the primary server is the physical machine according to the seventh aspect, and the secondary server is the physical machine according to the eighth aspect. Alternatively, the primary server is the physical machine according to the ninth aspect, and the secondary server is the physical machine according to the eleventh aspect. Alternatively, the primary server is the physical machine according to the thirteenth aspect, and the secondary server is the physical machine according to the fifteenth aspect.

For detailed descriptions of technical effects in the seventeenth aspect, refer to the related descriptions of technical effects in a corresponding aspect. Details are not described herein.

### BRIEF DESCRIPTION OF DRAWINGS

FIG. 1 is a schematic architectural diagram of a database system cluster according to an embodiment of the present disclosure;

FIG. 2 is a first schematic diagram of a data table processing method according to an embodiment of the present disclosure;

FIG. 3 is a second schematic diagram of a data table processing method according to an embodiment of the present disclosure;

FIG. 4 is a third schematic diagram of a data table processing method according to an embodiment of the present disclosure;

FIG. 5 is a fourth schematic diagram of a data table processing method according to an embodiment of the present disclosure;

FIG. 6A and FIG. 6B are fifth schematic diagrams of a data table processing method according to an embodiment of the present disclosure;

FIG. 7 is a first schematic diagram of another data table processing method according to an embodiment of the present disclosure;

FIG. 8 is a second schematic diagram of another data table processing method according to an embodiment of the present disclosure;

FIG. 9 is a first schematic structural diagram of a primary server according to an embodiment of the present disclosure;

FIG. 10 is a first schematic structural diagram of a secondary server according to an embodiment of the present disclosure;

FIG. 11 is a second schematic structural diagram of a primary server according to an embodiment of the present disclosure; and

FIG. 12 is a schematic hardware diagram of a physical machine according to an embodiment of the present disclosure.

### DESCRIPTION OF EMBODIMENTS

The character “/” in this specification generally indicates an “or” relationship between the associated objects. For example, A/B may be understood as A or B.

In the specification and claims of this application, the terms “first,” “second,” and the like are intended to distinguish between different objects, but do not indicate a particular order of the objects. For example, a first partition table, a second partition table, and the like are used to distinguish between different partition tables, but do not indicate a particular order of the partition tables.

In descriptions of this application, unless otherwise stated, “multiple” means “at least two”. For example, multiple services mean at least two services.

In addition, the terms “include,” “have,” or any other variant thereof mentioned in the descriptions of this application are intended to cover a non-exclusive inclusion. For example, a process, a method, a system, a product, or a device that includes a series of steps or units is not limited to the listed steps or units, but optionally further includes another unlisted step or unit, or optionally further includes another inherent step or unit of the process, the method, the product, or the device.

In the following description, for a purpose of illustration instead of limitation, specific details such as a particular system structure, an interface, and a technology are provided to make a thorough understanding of this application. However, a person skilled in the art should know that this application may be practiced in other embodiments without these specific details. In other cases, detailed descriptions of well-known apparatuses, circuits, and methods are omitted such that this application is described without being obscured by unnecessary details.

To facilitate a clearer understanding of implementations of the embodiments of the present disclosure, the following first defines/describes technical terms used in the embodiments of the present disclosure.

A partition technology partitions a data table into smaller segments according to a partition key. These segments logically belong to one tablespace, but are physically data independent of each other. The data independent of each other forms several data partitions.

A tablespace is a set of one or more data tables.

A data table is a table that includes data of multiple services. The table includes multiple rows and multiple columns, and each column or each row corresponds to one service. For ease of description, description is given using an example that each column corresponds to one service in the embodiments of the present disclosure. It should be understood that when each row corresponds to one service, the solutions of this application can also be executed, and specific manners are not described.

When each column corresponds to one service, a header of each column may be understood as one service, and data in each column may be understood as data of the service.

A partition key is a header that is of one or more columns and is for partitioning a data table, or a header that is of one or more rows and is for partitioning a data table. For ease of description, description is given using an example that the partition key is a header that is of one column and that is for partitioning a data table in the embodiments of the present disclosure. It should be understood that when the partition key is a header that is of multiple columns, or of one row, or of multiple rows, and, the partition key is for partitioning a data table, the solutions of this application can also be executed, and specific manners are not described.

It should be understood that when the partition key corresponds to a header of a column, a query instruction includes a query column. Correspondingly, when the partition key corresponds to a header of a row, a query column included in a query instruction may also be adaptively referred to as a query row, and the solutions of this application can also be executed. For ease of description, description is given using an example that the partition key is the header of the column in the embodiments of this application. It should be understood that when the partition key corresponds to the header of the row, the solutions of this application can also be executed, and specific manners are not described.

An instruction set is a set of multiple instructions.

A partition table is a data table obtained after partitioning is performed according to a partition key.

Partitioning is a process in which columns or rows in a data table that meet different conditions are grouped into different areas (which are also referred as partitions) according to a partition key. It should be noted that a row or column that is in a data table and is different from a row or column in which the partition key used for partitioning is located is usually not discarded in the partition process. For example, if a data table includes five columns, and is partitioned according to a header (that is, a partition key) of the third column, a data table (or each partition) obtained after the partitioning still includes five columns, that is, after the data table is partitioned, each partition includes all columns originally included in the data table. It may be understood that partitioning of a data table according to a header of a column is only grouping all rows in the data table into different partitions, but all columns in the data table exist in each partition. Correspondingly, partitioning of a data table according to a header of a row is only grouping all columns in the data table into different partitions, but all rows in the data table exist in each partition.

In an optional manner, to improve query efficiency, data in each partition may be further sorted after a data table is partitioned such that the data in each partition is physically sequentially stored.

In another optional manner, to improve query efficiency, data in a data table may be sorted first, and then the data table existing after the sorting is further partitioned. For example, a partition key may be set as an aggregation index such that the data in the data table is all physically sequentially stored according to the aggregation index. Next, the data table existing after the aggregation index is set is partitioned according to a partition condition corresponding to the partition key in order to complete partitioning of the data table.

It should be noted that a partition table is obtained after a data table is partitioned according to a partition key. The partition table may include multiple small tables (each small table is one partition), and the multiple small tables may be stored in same storage space, or may be stored in different storage space. However, regardless of how the multiple small tables are stored, the multiple small tables still logically mean one big table to a user. For example, a first partition table and a second partition table in this application logically mean one big table.

Further, in all the embodiments of the present disclosure, description is given using an example that the first partition table and the second partition table mean one big table, that is, both the first partition table and the second partition table in the embodiments of the present disclosure are logical concepts in software execution. Actually, partitions (that is, the foregoing small tables) in both the first partition table and the second partition table may further be physically stored in different sectors, that is, physically stored in different storage space. For example, it is assumed that the first partition table includes three partitions and each partition is one small table. In this case, the three small tables may be separately stored in different sectors on a hard disk of a physical machine.

A query column is a query parameter for querying a data table (or a partition table). For example, if the query parameter for querying a data table is c1 (for example, querying data that is in c1 and meets a condition), c1 is the query column. The query column has a concept similar to that of the foregoing partition key, and both are headers of one or more columns in a data table.

A partition pruning technology is a process in which an unnecessary partition is removed and a required partition is extracted, according to a from partition table in a query statement and a query column and a query condition in a where sub-statement. For example, if a data table is T, T is partitioned according to c1, a query column is c1, and a query condition is c1<200, using the partition pruning technology, a partition different from a partition meeting c1<200 may be removed from T, and the partition meeting c1<200 is extracted, which is data that is in T and that meets the query condition.

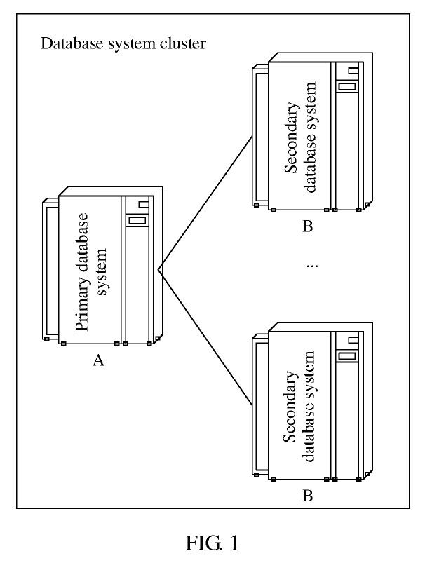

A data table processing method provided in an embodiment of the present disclosure may be applied to a database system cluster. As shown in FIG. 1, FIG. 1 is a schematic architectural diagram of a database system cluster according to an embodiment of the present disclosure. The database system cluster includes one primary server A and several secondary servers B connected to the primary server. Database systems run on both the primary server and the secondary servers. To better understand database systems running on different physical machines, a database system running on the primary server is usually referred to as a primary database system, and a database system running on each secondary server is referred to as a secondary database system. For example, as shown in FIG. 1, the database system cluster in this embodiment of the present disclosure includes a hardware entity and a software environment. The hardware entity includes the primary server A and the several secondary servers B, and the software environment includes a primary database system and several secondary database systems.

In the database system cluster provided in this embodiment of the present disclosure, for specific implementation of the primary server, refer to related descriptions, in the following embodiments, of a structure of the primary server, hardware of the primary server, a data table processing method that is provided in the embodiments of the present disclosure and is executed by the primary server. Details are not described herein. For specific implementation of the secondary server, refer to related descriptions, in the following embodiments, of a structure of the secondary server, hardware of the secondary server, a data table processing method that is provided in the embodiments of the present disclosure and is executed by the secondary server. Details are not described herein.

In this embodiment of the present disclosure, during specific implementation, a state in which a database system runs may be used to identify whether the database system is a primary database system or a secondary database system. Further, when a state in which a database system runs is an “active” state, it indicates that the database system is a primary database system. When a state in which a database system runs is a “standby” state, it indicates that the database system is a secondary database system. If a database system is a primary database system, it indicates that one or more secondary database systems are connected to the primary database system. If a database system is a secondary database system, it indicates that the secondary database system is connected to a primary database system.

A person skilled in the art may understand that the active database system (or the primary server) and the secondary database system (or the secondary server) in this embodiment of the present disclosure are relative concepts, that is, the primary database system and the secondary database system are not absolutely unchanged, but may be changed according to an actual application requirement/scenario/environment. No limitation is imposed in this embodiment of the present disclosure. For example, it is assumed that a database system 1 is a primary database system and a database system 2 is a secondary database system in a scenario. When the scenario is changed, that is, in another scenario, the database system 1 may be a secondary database system and the database system 2 may be a primary database system.

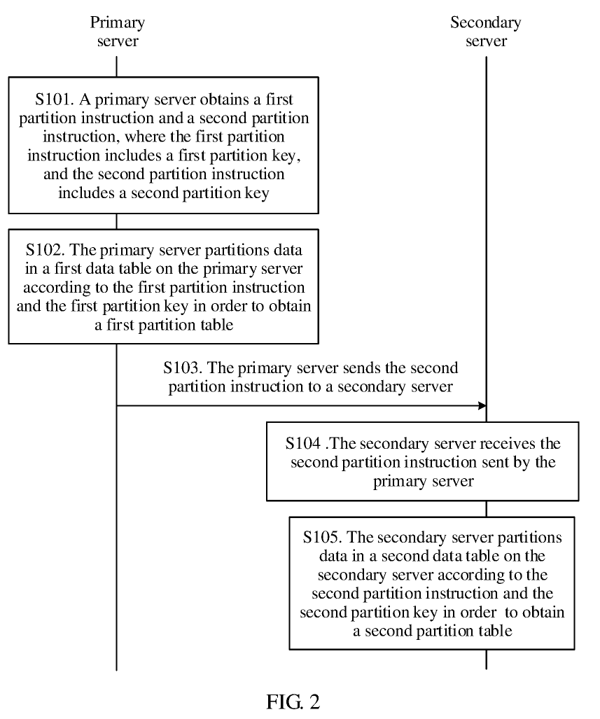

Based on the database system cluster shown in FIG. 1, as shown in FIG. 2, an embodiment of the present disclosure provides a data table processing method. The processing method may be applied to a primary server and a secondary server in a database system cluster, and the processing method may include the following steps.

Step S101. The primary server obtains a first partition instruction and a second partition instruction, where the first partition instruction includes a first partition key, and the second partition instruction includes a second partition key.

The first partition instruction is used to partition a first data table on the primary server according to a first partition key, and the second partition instruction is used to partition a second data table on the secondary server according to a second partition key. The first data table is the same as the second data table, and the first partition key is different from the second partition key.

In this embodiment of the present disclosure, the first data table on the primary server indicates a data table that can be read by the primary server. For example, the first data table may be stored in a storage medium of the primary server, or may be stored in a storage device such as a storage server corresponding to the primary server. No limitation is imposed in this embodiment of the present disclosure. The second data table on the secondary server indicates a data table that can be read by the secondary server. For example, the second data table may be stored in a storage medium of the secondary server, or may be sent by the primary server to the secondary server, or may be stored in a storage device such as a storage server corresponding to the secondary server. No limitation is imposed in this embodiment of the present disclosure.

The first data table may include data of multiple services, and data of each service may be understood as one column of data in the first data table, that is, each service may be understood as a header of one column in the first data table. In this way, the first partition key may be understood as one of the multiple services, that is, the first partition key may be understood as a header of one column in the first data table. A first partition table is a partition table corresponding to the service. The second data table, the second partition key, and a second partition table are respectively similar to the first data table, the first partition key, and the first partition table. Details are not described herein.

In an optional implementation, in the data table processing method provided in this embodiment of the present disclosure, before S101, the processing method further includes obtaining, by the primary server, a first creation instruction and a second creation instruction, where the first creation instruction is used to create the first data table on the primary server, and the second creation instruction is used to create the second data table on secondary server, creating, by the primary server, the first data table on the primary server according to the first creation instruction, and sending, by the primary server, the second creation instruction to the secondary server such that the secondary server creates the second data table on the secondary server according to the second creation instruction.

Optionally, in this embodiment of the present disclosure, the primary server may simultaneously obtain the first creation instruction, the first partition instruction, the second creation instruction, and the second partition instruction.

Further, in an optional implementation, the primary server obtains a first instruction set and a second instruction set. The first instruction set includes the first creation instruction and the first partition instruction, and the second instruction set includes the second creation instruction and the second partition instruction.

For example, in this embodiment of the present disclosure, the first creation instruction and the first partition instruction may be further represented as follows:
create table T (c1 int, c2 int)
partition by range(c1)
(partition c1_p1 values less than(100),
partition c1_p2 values less than (200),
partition c1_p3 values less than(300)).

The first creation instruction is as follows:
create table T (c1 int, c2 int).

The first partition instruction is as follows:
partition by range(c1)
(partition c1_p1 values less than(100),
partition c1_p2 values less than (200),
partition c1_p3 values less than(300)).

The first partition key in the first partition instruction is c1 (that is, the first partition key may be understood as a header of a c1 column in the foregoing data table).

Further, the first partition instruction is used to instruct to partition the first data table according to the cl column. For example, all rows in which values of the c1 column are less than 100 in the first data table are grouped into a first partition (which may be represented by the foregoing c1_p1), all rows in which values of the c1 column are less than 200 in the first data table are grouped into a second partition (which may be represented by the foregoing c1_p2), all rows in which values of the c1 column are less than 300 in the first data table are grouped into a third partition (which may be represented by the foregoing c1_p3), and the like.

For example, in this embodiment of the present disclosure, the second creation instruction and the second partition instruction may be further represented as follows:
create table T (c1 int, c2 int)
partition by range(c2)
(partition c2_p1 values less than(1000),
partition c2_p2 values less than(2000),
partition c2_p3 values less than (3000),
partition c2_p4 values less than (4000)).

The second creation instruction is as follows:
create table T (c1 int, c2 int).

The second partition instruction is as follows:
partition by range(c2)
(partition c2_p1 values less than(1000),
partition c2_p2 values less than(2000),
partition c2_p3 values less than (3000),
partition c2_p4 values less than (4000)).

The second partition key in the second partition instruction is c2 (that is, the second partition key may be understood as a header of a c2 column in the foregoing data table).

Because the first partition key is different from the second partition key, the c1 column and the c2 column are two different columns in the data table, that is, the header of the c1 column and the header of the c2 column are different, and the header of the c1 column and the header of the c2 column respectively represent different services.

Further, the second partition instruction is used to instruct to partition the second data table according to the c2 column. For example, all rows in which values of the c2 column are less than 1000 in the second data table are grouped into a first partition (which may be represented by the foregoing c2_p1), all rows in which values of the c2 column are less than 2000 in the second data table are grouped into a second partition (which may be represented by the foregoing c2_p2), all rows in which values of the c2 column are less than 3000 in the second data table are grouped into a third partition (which may be represented by the foregoing c2_p3), all rows in which values of the c2 column are less than 4000 are grouped into a fourth partition (which may be represented by the foregoing c2_p4), and the like.

Step S102. The primary server partitions data in a first data table on the primary server according to the first partition key in order to obtain a first partition table.

For example, in this embodiment of the present disclosure, it is assumed that the first data table created by the primary server according to the first creation instruction is table 1 (which may be represented as T). In this case, table 1 may be represented as follows:

TABLE 1
(T)

| | | | Age | |
|---|---|---|---|---|
| Row | Customer | | (years | Balance |
| number | name | Account | old) | (Yuan) |
| 1 | Li XX | 056 | 15 | 859 |
| 2 | Zhang XX | 089 | 16 | 1236 |
| 3 | Xu XX | 168 | 16 | 2568 |
| 4 | Wang XX | 076 | 20 | 3689 |
| 5 | Zhang XX | 273 | 14 | 1569 |
| 6 | Zhang XX | 105 | 18 | 2880 |
| 7 | Xu XX | 289 | 25 | 3786 |
| 8 | Wang XX | 295 | 31 | 3900 |

A header of each column in the foregoing table 1 may represent one service. For example, table 1 includes four services such as a customer name, an account, an age, and a balance.

In this embodiment of the present disclosure, it is assumed that the first partition key (which, for example, is c1 in the first partition instruction in the foregoing example) is the account in the foregoing table 1. In this case, the first partition table obtained after the primary server partitions data in table 1 according to the account and the first partition instruction (that is, a condition met by the first partition key in the first partition instruction in the foregoing example) in the foregoing example may be represented as table 2 (because data in table 2 is the same as that in table 1, table 2 may be still represented as T).

TABLE 2
(T)

| | | | Age | |
|---|---|---|---|---|
| Row | Customer | | (years | Balance |
| number | name | Account | old) | (Yuan) |
| 1 | Li XX | 056 | 15 | 859 |
| 4 | Wang XX | 076 | 20 | 3689 |
| 2 | Zhang XX | 089 | 16 | 1236 |
| 6 | Zhang XX | 105 | 18 | 2880 |
| 3 | Xu XX | 168 | 16 | 2568 |
| 5 | Zhang XX | 273 | 14 | 1569 |
| 7 | Xu XX | 289 | 25 | 3786 |
| 8 | Wang XX | 295 | 31 | 3900 |

It can be learned from table 2 that in this embodiment of the present disclosure, the first partition table obtained after the primary server partitions table 1 according to the account may include three partitions. It is assumed that the three partitions are respectively represented as c1_p1 (in which the account is less than 100), c1_p2 (in which the account is less than 200), and c1_p3 (in which the account is less than 300). In this case, c1_p1 includes data in three rows whose row numbers are 1, 2, and 4 in table 2, c1_p2 includes data in five rows whose row numbers are 1 to 4 and 6 in table 2, and c1_p3 includes data in eight rows whose row numbers 1 to 8 in table 2.

Step S103. The primary server sends the second partition instruction to the secondary server.

The second partition instruction is used to trigger the secondary server to partition data in the second data table on the secondary server according to the second partition key in order to obtain the second partition table.

Step S104. The secondary server receives the second partition instruction sent by the primary server.

Step S105. The secondary server partitions data in a second data table on the secondary server according to the second partition instruction in order to obtain a second partition table.

In this embodiment of the present disclosure, the second data table on the secondary server may be pre-stored in the secondary server, or may be sent by the primary server to the secondary server before the primary server executes the data table processing method provided in this embodiment of the present disclosure, or may be sent by the primary server to the secondary server when the primary server sends the second partition instruction to the secondary server. Further, the second data table may be determined according to an actual use requirement. No limitation is imposed in this embodiment of the present disclosure.

In this embodiment of the present disclosure, the first data table on the primary server is the same as the second data table on the secondary server. Therefore, for example, it is assumed that the second data table created by the secondary server according to the second creation instruction is also the foregoing table 1, and the second partition key (which, for example, is c2 in the second partition instruction in the foregoing example) is the balance in the foregoing table 1. In this case, the second partition table obtained after the secondary server partitions the data in table 1 according to the balance and the second partition instruction (that is, a condition met by the second partition key in the second partition instruction in the foregoing example) in the foregoing example may be represented as table 3 (because data in table 3 is the same as that in table 1, table 3 may be still represented as T).

TABLE 3
(T)

| | | | Age | |
|---|---|---|---|---|
| Row | Customer | | (years | Balance |
| number | name | Account | old) | (Yuan) |
| 1 | Li XX | 056 | 15 | 859 |
| 2 | Zhang XX | 089 | 16 | 1236 |
| 5 | Zhang XX | 273 | 14 | 1569 |
| 3 | Xu XX | 168 | 16 | 2568 |
| 6 | Zhang XX | 105 | 18 | 2880 |
| 4 | Wang XX | 076 | 20 | 3689 |
| 7 | Xu XX | 289 | 25 | 3786 |
| 8 | Wang XX | 295 | 31 | 3900 |

It can be learned from table 3 that in this embodiment of the present disclosure, the second partition table obtained after the secondary server partitions table 1 according to the balance may include four partitions. It is assumed that the four partitions are respectively represented as c2_p1 (in which the balance is less than 1000), c2_p2 (in which the balance is less than 2000), c2_p3 (in which the balance is less than 3000), and c2_p4 (in which the balance is less than 4000). In this case, c2_p1 includes data in one row whose row number is 1 in table 3, c2_p2 includes data in three rows whose row numbers are 1, 2, and 5 in table 3, c2_p3 includes data in five rows whose row numbers are 1 to 3 and 5 and 6 in table 3, and c2_p4 includes data in eight rows whose row numbers are 1 to 8 in table 3.

In specific implementation, each partition in the foregoing table 2 and each partition in the foregoing table 3 may also be small tables independently. The small tables may be physically stored in different sectors, that is, physically stored in different storage space. For example, the foregoing table 2 is a big table, the big table includes three small tables, the three small tables correspond to the three partitions included in table 2, and the three small tables may be physically stored in different sectors. The foregoing table 3 is also a big table, the big table includes four small tables, the four small tables correspond to the four partitions included in table 3, and the four small tables may be physically stored in different sectors. In this embodiment of the present disclosure, description is given only using an example that table 2 and table 3 are big tables, that is, table 2 and table 3 are logical concepts in software execution.

Further, in the data table processing method provided in this embodiment of the present disclosure, after the primary server and the secondary server each obtain the partition table according to the foregoing method procedure shown in FIG. 2, required data in a corresponding partition table may be queried according to a query column and a query condition in a query instruction obtained by the primary server. A process of querying a partition table is described in detail in the following embodiment.

In the data table processing method provided in this embodiment of the present disclosure, the first data table may be partitioned on the primary server according to the first partition key in order to obtain the first partition table. The second data table that is the same as the first data table is partitioned on the secondary server according to the second partition key different from the first partition key in order to obtain the second partition table. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

Further, after a partition table is obtained by partitioning a data table using the data table processing method provided in this embodiment of the present disclosure, if the partition table is queried using a partition pruning technology, it may be ensured that a partition meeting a query condition in the partition can be accurately obtained by means of screening.

Further, after a data table is partitioned using the data table processing method provided in this embodiment of the present disclosure, because different partition tables are separately stored in different physical machines (for example, the first partition table obtained by means of partition according to the first partition key is stored in the primary server, and the second partition table obtained by means of partition according to the second partition key is stored in the secondary server), the primary server does not need to store a redundant partition table such that system performance of the primary server can be improved.

Further, using the data table processing method provided in this embodiment of the present disclosure, the secondary server may store a partition table different from a partition table stored in the primary server. Therefore, when a query requirement is ever-increasing, the secondary server may be expanded when load of the primary server is not increased in order to meet the query requirement. Therefore, a query capability of the database system cluster is improved.

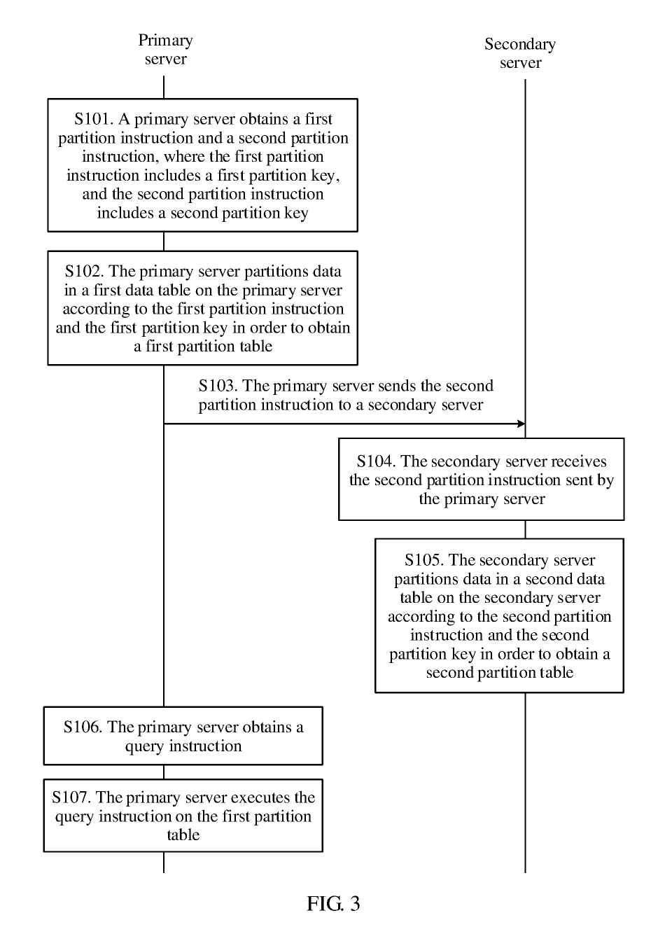

Optionally, with reference to FIG. 2, as shown in FIG. 3, after step S105, the data table processing method provided in this embodiment of the present disclosure may further include the following steps.

Step S106. The primary server obtains a query instruction.

The query instruction includes a query column and a query condition. The query column is the same as the first partition key.

Step S107. The primary server executes the query instruction on the first partition table.

The query instruction may be entered by a user using an input interface of the primary server, or may be sent by a network node to the primary server. Further, the query instruction may be determined according to an actual application scenario. No limitation is imposed in this embodiment of the present disclosure. The query instruction may be used to query data that is in the first partition table and that meets the query condition.

For example, it is assumed that the query instruction is select * from T where c1<200. In this case, in the query instruction, the query column is c1, and the query condition is c1 is less than 200. Because the query column is the same as the first partition key, the query instruction may be used to query data that is in c1 and is less than 200 in the first partition table. For example, with reference to the foregoing table 1 and table 2, the query instruction may be used to query data that is in the account and is less than 200 in the first partition table shown by table 2, that is, the data in the five rows whose row numbers are 1 to 4 and 6 in table 2. In addition, the query instruction may also be understood as finding a partition that meets c1<200 in the first partition table.

Further, that the primary server executes the query instruction on the first partition table may be understood as querying, by the primary server, the data that is in the first partition table and that meets the query condition. For example, based on the foregoing table 2, the primary server queries the data (that is, the foregoing c1_p2, including the data in the five rows whose row numbers are 1 to 4 and 6 in table 2) that is in the account and is less than 200 in the first partition table.

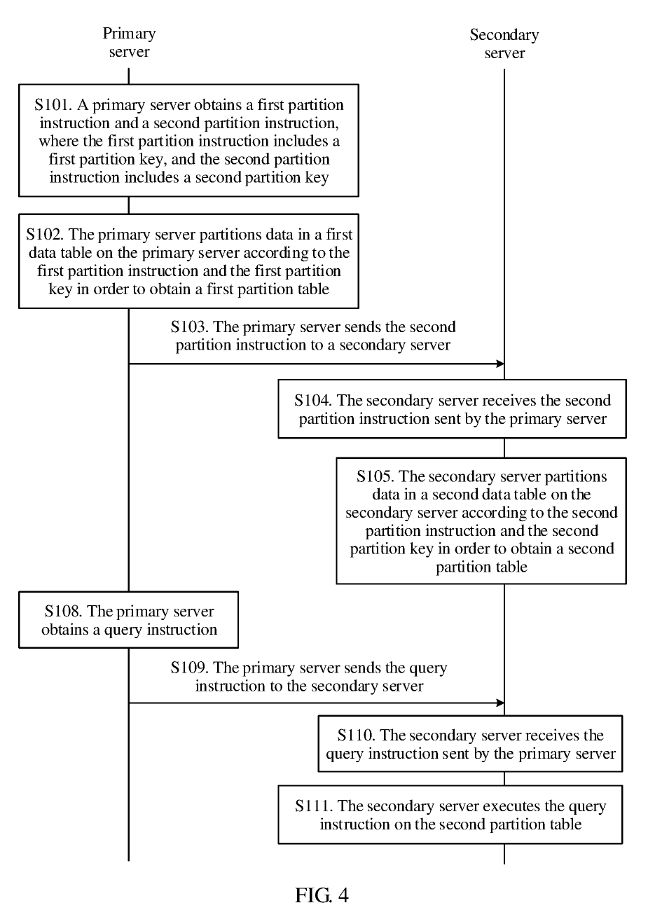

Optionally, with reference to FIG. 2, as shown in FIG. 4, after step S105, the data table processing method provided in this embodiment of the present disclosure may further include the following steps.

Step S108. The primary server obtains a query instruction.

The query instruction includes a query column and a query condition. The query column is the same as the second partition key.

Step S109. The primary server sends the query instruction to the secondary server.

Step S110. The secondary server receives the query instruction sent by the primary server.

Step S111. The secondary server executes the query instruction on the second partition table.

For detailed description of the query instruction, refer to related description of the query instruction in the embodiment shown in FIG. 3. Details are not described herein again.

For example, it is assumed that the query instruction is select * from T where c2<2000. In this case, in the query instruction, the query column is c2, and the query condition is c2 is less than 2000. Because the query column is the same as the second partition key, the query instruction may be used to query data that is in c2 and is less than 2000 in the second partition table. For example, with reference to the foregoing table 1 and table 3, the query instruction may be used to query data that is in the balance and is less than 2000 in the second partition table shown by table 3, that is, the data in the three rows whose row numbers are 1, 2, and 5 in table 3. In addition, the query instruction may also be understood as finding a partition that meets c2<2000 in the second partition table.

Further, that the secondary server executes the query instruction on the second partition table may be understood as querying, by the secondary server, data that is in the second partition table and that meets the query condition. For example, based on the foregoing table 3, the secondary server queries the data (that is, the foregoing c2_p2, including the data in the three rows whose row numbers are 1, 2, and 5 in table 3) that is in the balance and is less than 2000 in the second partition table.

With reference to FIG. 3 and FIG. 4, in the data table processing method provided in this embodiment of the present disclosure, after the primary server and the secondary server each obtain a corresponding partition table, if the primary server receives the query instruction entered by the user or sent by a network node, the primary server first determines whether the query column in the query instruction is the same as the first partition key on the primary server or the second partition key on the secondary server. If the primary server determines that the query column is the same as the first partition key on the primary server, the primary server executes the query instruction on the first partition table. If the primary server determines that the query column is the same as the second partition key on the secondary server, the primary server sends the query instruction to the secondary server such that the secondary server executes the query instruction on the second partition table. If the primary server determines that the query column is different from both the first partition key on the primary server and the second partition key on the secondary server, the primary server executes the query instruction by default. Further, the primary server queries data in the first partition table row by row in order to find the data that is in the first partition table and that meets the query condition.

Further, during a query of a partition table, to improve query efficiency, the partition pruning technology is usually used to query the partition table. For detailed description of the partition pruning technology, refer to the foregoing definition of the partition pruning technology in this embodiment. Details are not described herein again.

In this embodiment of the present disclosure, when a service needs to be queried, it may be determined, according to a query column included in a query instruction, whether the primary server or the secondary server executes the query instruction, that is, it is determined that one server of the primary server and the secondary server executes the query instruction provided that the server obtains a partition table by means of partition according to a partition key the same as the query column. In this way, the storage space of the physical machines in the database system cluster can be saved (because each physical machine does not need to store multiple same partition tables, a quantity of partition tables stored in each physical machine in the database system cluster can be reduced) while query efficiency is improved (data meeting a query condition needs to be obtained by performing screening only in a corresponding partition instead of in an entire data table).

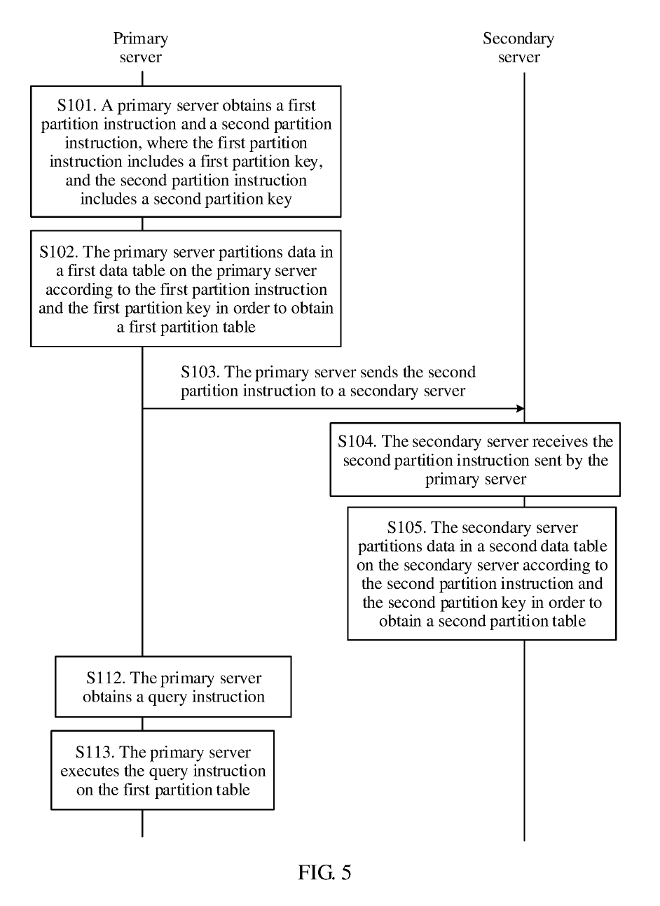

Optionally, with reference to FIG. 2, as shown in FIG. 5, after step S105, the data table processing method provided in this embodiment of the present disclosure may further include the following steps.

Step S112. The primary server obtains a query instruction.

The query instruction includes a first query column, a first query condition corresponding to the first query column, a second query column, and a second query condition corresponding to the second query column. The first query column is the same as the first partition key. The second query column is the same as the second partition key. An “and” relationship exists between the first query condition and the second query condition. The query instruction is used to query data that is in the first partition table and that meets the first query condition and the second query condition.

For ease of understanding of a specific implementation in this embodiment of the present disclosure, description is given using an example that the query instruction includes two query columns and two query conditions in this embodiment of the present disclosure. A specific implementation in which at least two query columns and at least two query conditions are included is similar to a specific implementation in which two query columns and two query conditions are included. Details are not described herein.

Step S113. The primary server executes the query instruction on the first partition table.

After the primary server obtains the query instruction, first, the primary server may determine that the query instruction includes the first query column, the first query condition corresponding to the first query column, the second query column, and the second query condition corresponding to the second query column. Next, the primary server further determines whether the first query column and the second query column are the same as the first partition key and the second partition key. If the primary server determines that the first query column is the same as the first partition key and the second query column is the same as the second partition key, and that an “and” relationship exists between the first query condition and the second query condition, the primary server executes the query instruction on the first partition table.

In this embodiment, the query instruction includes both the first query column the same as the first partition key on the primary server, and the second query column the same as the second partition key on the secondary server. A process in which the primary server and the secondary server perform intersection on a query result after separately performing a query is extremely complex, wherein the query result is according to a corresponding query column and query condition. Therefore, to reduce query complexity, the primary server may directly execute the query instruction on the first partition table by default. Further, the primary server may query data that is in the first partition table and that meets the first query condition, and then the primary server further queries data that is in the data meeting the first query condition and that meets the second query condition. Alternatively, the primary server may query data that is in the first partition table and that meets the second query condition, and then the primary server further queries data that is in the data meeting the second query condition and that meets the first query condition. No limitation is imposed in this embodiment of the present disclosure.

For example, it is assumed that the query instruction is select * from T where c1<200 and c2<2000. The query instruction includes both the first query column c1 the same as the first partition key on the primary server and the second query column c2 the same as the second partition key on the secondary server, and an “and” relationship exists between the two query conditions (that is, c1<200 and c2<2000). Therefore, to reduce query complexity, the primary server may directly execute the query instruction on the first partition table in order to determine data (such as data in two rows whose row numbers are 1 and 2 in table 2) meeting both c1<200 and c2<2000 from the first partition table.

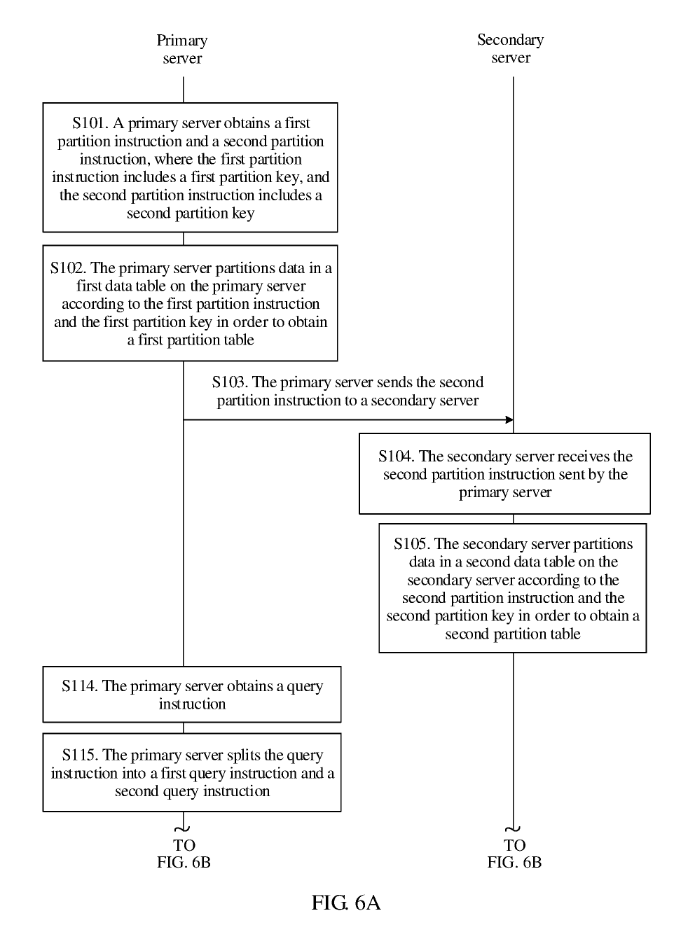

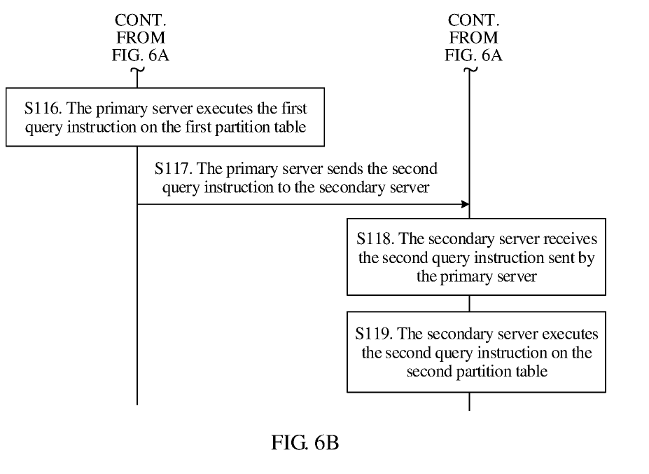

Optionally, with reference to FIG. 2, as shown in FIG. 6A and FIG. 6B, after step S105, the data table processing method provided in this embodiment of the present disclosure may further include the following steps.

Step S114. The primary server obtains a query instruction.

The query instruction includes a first query column, a first query condition corresponding to the first query column, a second query column, and a second query condition corresponding to the second query column. The first query column is the same as the first partition key. The second query column is the same as the second partition key. For other detailed description of step S114, refer to related description of step S112 in the embodiment shown in FIG. 5. Details are not described herein.

A difference between steps S114 and S112 is as follows.

In step S112, an “and” relationship exists between the first query condition and the second query condition, and in step S114, an “or” relationship exists between the first query condition and the second query condition. In addition, in step S112, the query instruction is used to query the data that is in the first partition table and that meets the first query condition and the second query condition, and in step S114, the query instruction is used to query data that is in the first partition table and that meets the first query condition, and query data that is in the second partition table and that meets the second query condition.

Step S115. The primary server splits the query instruction into a first query instruction and a second query instruction.

The first query instruction includes the first query column and the first query condition, and is used to query the data that is in the first partition table and that meets the first query condition. The second query instruction includes the second query column and the second query condition, and is used to query the data that is in the second partition table and that meets the second query condition.

Step S116. The primary server executes the first query instruction on the first partition table.

Step S117. The primary server sends the second query instruction to the secondary server.

Step S118. The secondary server receives the second query instruction sent by the primary server.

Step S119. The secondary server executes the second query instruction on the second partition table.

It should be noted that a sequence of performing steps S116 and S117 is not limited in this embodiment of the present disclosure. That is, in this embodiment of the present disclosure, step S116 may be performed before step S117, or step S117 may be performed before step S116, or steps S116 and S117 may be simultaneously performed.

In this embodiment of the present disclosure, because the first query column in the first query instruction is the same as the first partition key in the first partition table on the primary server, the primary server may execute the first query instruction on the first partition table. Correspondingly, because the second query column in the second query instruction is the same as the second partition key in the second partition table on the secondary server, the secondary server may execute the second query instruction on the second partition table.

For example, it is assumed that the query instruction is select * from T where c1<200 or c2<2000. The query instruction includes both the first query column c1 the same as the first partition key on the primary server and the second query column c2 the same as the second partition key on the secondary server, and an “or” relationship exists between the two query conditions (that is, c1<200 or c2<2000). Therefore, the primary server may split the query instruction into two query instructions, the first query instruction and the second query instruction. The first query instruction may be represented as select * from T where c1<200, and the second query instruction may be represented as select * from T where c2<2000.

In this embodiment of the present disclosure, when a query instruction includes two query conditions (which may also be multiple query conditions in actual use), the primary server may determine, according to a relationship between the two query conditions, a specific physical machine (the primary server or the secondary server) for executing the query instruction. Therefore, based on a partition table obtained using the data table processing method provided in this embodiment of the present disclosure, query efficiency during a query of the partition table can be improved to some extent.

In the data table processing method provided in this embodiment of the present disclosure, the foregoing query instruction may further include a larger quantity of query columns. Further, when the foregoing query instruction includes multiple query columns, the method procedures shown in FIG. 5 and FIG. 6A and FIG. 6B may be still used in query procedures executed by the primary server and the secondary server. For example, if an “and” relationship exists between multiple query conditions, the method procedure shown in FIG. 5 is used, that is, the primary server executes the query instruction on the first partition table. If an “or” relationship exists between multiple query conditions, the method procedure shown in FIG. 6A and FIG. 6B is used, that is, the primary server and the secondary server execute the query instruction (further, the primary server executes the first query instruction obtained by splitting the query instruction, and the secondary server executes the second query instruction obtained by splitting the query instruction). Certainly, for a case in which both an “and” relationship and an “or” relationship exist between multiple query conditions, in specific implementation, with reference to the method procedures shown in FIG. 5 and FIG. 6A and FIG. 6B, it may be further designed that the primary server executes the method procedure shown in FIG. 5 and the secondary server executes the method procedure shown in FIG. 6A and FIG. 6B. In actual application of a database system, during a query of a data table (or a partition table), an “and” relationship usually exists between multiple query conditions, or an “or” relationship usually exists between multiple query conditions. Therefore, for the case in which both an “and” relationship and an “or” relationship exist between multiple query conditions, details are not described herein in this embodiment of the present disclosure.

A person skilled in the art may understand with reference to FIG. 3, FIG. 4, FIG. 5, and FIG. 6A and FIG. 6B that, if the query instruction includes one query condition, the primary server and the secondary server in this embodiment of the present disclosure execute the method procedure shown in FIG. 3 or FIG. 4, or if the query instruction includes multiple query conditions, the primary server and the secondary server in this embodiment of the present disclosure execute the method procedure shown in FIG. 5 or FIG. 6A and FIG. 6B.

Optionally, in the data table processing method provided in this embodiment of the present disclosure, that the primary server obtains a first instruction set and a second instruction set in step S101 may further include obtaining, by the primary server, an instruction set, where the instruction set includes a creation instruction, the first partition instruction, and the second partition instruction, generating, by the primary server, the first instruction set according to the creation instruction and the first partition instruction, and generating the second instruction set according to the creation instruction and the second partition instruction.

The instruction set may be entered by the user using the input interface of the primary server, or may be sent by a network node to the primary server. Further, the instruction set may be determined according to an actual application scenario. No limitation is imposed in this embodiment of the present disclosure.

For example, in this embodiment of the present disclosure, the instruction set may be represented as follows:
create table T (c1 int, c2 int)
partition by range(c1) on primary
(partition c1_p1 values less than(100),
partition c1_p2 values less than (200),
partition c1_p3 values less than(300))
partition by range(c2) on standby
(partition c2_p1 values less than(1000),
partition c2_p2 values less than(2000),
partition c2_p3 values less than (3000),
partition c2_p4 values less than (4000)).

The creation instruction in the foregoing instruction set is as follows:
create table T (c1 int, c2 int).

The first partition instruction in the foregoing instruction set is as follows:
partition by range(c1) on primary
(partition c1_p1 values less than(100),
partition c1_p2 values less than (200),
partition c1_p3 values less than(300)).

The second partition instruction in the foregoing instruction set is as follows:
partition by range(c2) on standby
(partition c2_p1 values less than(1000),
partition c2_p2 values less than(2000),
partition c2_p3 values less than (3000),
partition c2_p4 values less than (4000)).

It should be noted that the first partition instruction in the instruction set is totally equivalent to the first partition instruction in the foregoing first instruction set, and the second partition instruction in the instruction set is also totally equivalent to the second partition instruction in the foregoing second instruction set. Because the instruction set includes both the first partition instruction and the second partition instruction, the first partition instruction in the instruction set further instructs to perform partition (which is the foregoing partition by range(c1) on primary) on the primary server according to the first partition key c1, and the second partition instruction in the instruction set further instructs to perform partition (partition by range(c2) on standby) on the secondary server according to the second partition key c2.

For detailed descriptions of the first instruction set and the second instruction set, refer to related descriptions of the first instruction set and the second instruction set in S101. Details are not described herein again.

Optionally, in the data table processing method provided in this embodiment of the present disclosure, after the primary server obtains the first partition table and the secondary server obtains the second partition table, the primary server and the secondary server may synchronize the first partition table and the second partition table with each other using a logical log, that is, the primary server and the secondary server may keep data in the first partition table and data in the second partition table consistent with each other using the logical log.

Further, that the primary server and the secondary server perform synchronization with each other using the logical log may be understood as follows After the primary server receives a modification instruction, the primary server directly sends the modification instruction to the secondary server such that the primary server and the secondary server separately modify their respective partition tables by executing the modification instruction.

For example, the data table processing method provided in this embodiment of the present disclosure may further include receiving, by the primary server, a modification instruction, modifying, by the primary server, the first partition table according to the modification instruction, sending, by the primary server, the modification instruction to the secondary server, receiving, by the secondary server, the modification instruction sent by the primary server, and modifying, by the secondary server, the second partition table according to the modification instruction.

The modification instruction is used to modify data in a data table (which may further include the first data table and the second data table). The modification includes insertion, deleting, changing, or the like.

Using the method procedure in this embodiment, it may be ensured that data tables (or partition tables) on the primary server and the secondary server are synchronized. In this embodiment of the present disclosure, using steps S101 to S105, the primary server and the secondary server may create a same data table. Correspondingly, using the method procedure in this embodiment, after the primary server receives the modification instruction, the primary server modifies the first partition table on the primary server according to the modification instruction, and the primary server sends the modification instruction to the secondary server such that the secondary server also modifies the second partition table on the secondary server according to the modification instruction. Therefore, it can be still ensured that the data in the first partition table on the primary server is kept consistent with the data in the second partition table on the secondary server.

In this embodiment of the present disclosure, compared with a method in which the primary server and the secondary server synchronize their respective partition tables with each other using a physical log (that synchronization is performed using the physical log may be understood as follows. The primary server sends modified data to the secondary server, and the secondary server updates the data), in the method in which the primary server and the secondary server synchronize their respective partition tables with each other using the logical log, the primary server directly sends the modification instruction (overheads of the modification instruction are much fewer than overheads of data) to the secondary server such that the secondary server modifies the partition table of the secondary server by executing the modification instruction. Therefore, synchronization overheads for synchronizing the first partition table on the primary server with the second partition table on the secondary server can be reduced.

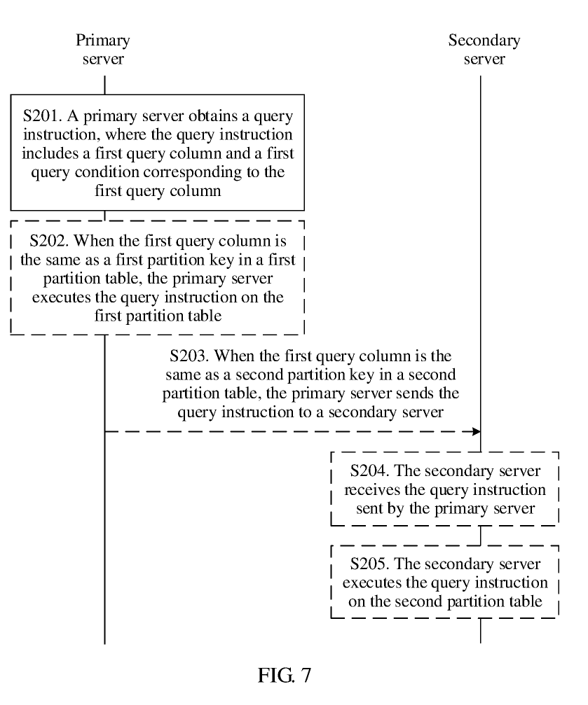

As shown in FIG. 7, an embodiment of the present disclosure provides a data table processing method. The processing method is applied to a primary server in a database system cluster, the database system cluster includes the primary server and a secondary server, the processing method includes the following steps.

Step S201. The primary server obtains a query instruction, where the query instruction includes a first query column and a first query condition corresponding to the first query column.

The query instruction is used to query data that is in a partition table and that meets the first query condition.

Step S202. When the first query column is the same as a first partition key in a first partition table, the primary server executes the query instruction on the first partition table.

The first partition table is obtained by partitioning data in a first data table on the primary server according to the first partition key. The first data table may include data of multiple services, and data of each service may be understood as one column of data in the first data table, that is, each service may be understood as a header of one column in the first data table. In this way, the first partition key may be understood as one of the multiple services, that is, the first partition key may be understood as a header of one column in the first data table. The first partition table is a partition table corresponding to the service.

In this embodiment of the present disclosure, for other detailed descriptions of steps S201 and S202, refer to related descriptions and examples of steps S106 and S107 in the embodiment shown in FIG. 3. To avoid repetition, details are not described herein.

In this embodiment of the present disclosure, before step S201 is performed, the primary server creates the first data table on the primary server, and partitions the data in the first data table according to the first partition key in order to obtain the first partition table, and the secondary server creates, on the secondary server, a second data table that is the same as the first data table, and partitions the second data table according to a second partition key in order to obtain a second partition table. Further, for a method in which the primary server creates the first data table and obtains the first partition table and a method in which the secondary server creates the second data table and obtains the second partition table, refer to related descriptions and examples of steps S101 to S105 in the embodiment shown in FIG. 2. To avoid repetition, details are not described herein.

Step S203. When the first query column is the same as a second partition key in a second partition table, the primary server sends the query instruction to the secondary server.

Step S204. The secondary server receives the query instruction sent by the primary server.

Step S205. The secondary server executes the query instruction on the second partition table.

The second partition table is obtained by partitioning data in the second data table on the secondary server according to the second partition key. The second data table is the same as the first data table on the primary server. The second partition key is different from the first partition key. The second data table, the second partition key, and the second partition table are respectively similar to the first data table, the first partition key, and the first partition table. For details, refer to related descriptions of the first data table, the first partition key, and the first partition table. Details are not described herein.

In this embodiment of the present disclosure, for detailed descriptions of steps S201 and S203 to S205, refer to related descriptions and examples of steps S108 to S111 in the embodiment shown in FIG. 4. To avoid repetition, details are not described herein.

It should be noted that, after step S201, either step S202 is performed or steps S203 to S205 are performed, that is, after step S201, step S202 is performed, or steps S203 to S205 are performed. To clearly describe performing of steps S202 and S203 to S205, both steps S202 and S203 to S205 are represented by dashed lines in FIG. 7.

In the data table processing method provided in this embodiment of the present disclosure, the first partition table is obtained by partitioning the data in the first data table on the primary server according to the first partition key, and the second partition table is obtained by partitioning, according to the second partition key, the data in the second data table that is on the secondary server and is the same as the first data table. Therefore, when the first query column in the query instruction obtained by the primary server is the same as the first partition key, the primary server may execute the query instruction on the first partition table, or when the first query column in the query instruction obtained by the primary server is the same as the second partition key, the primary server may send the query instruction to the secondary server such that the secondary server executes the query instruction on the second partition table. A same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

Optionally, in this embodiment of the present disclosure, when the first query column is the same as the first partition key in the first partition table, the query instruction further includes a second query column and a second query condition. The second query column is the same as the second partition key in the second partition table. An “and” relationship exists between the first query condition and the second query condition. The query instruction is further used to query data that is in the first partition table and that meets the second query condition. The second partition table is obtained by partitioning the data in the second data table on the secondary server according to the second partition key. The second data table is the same as the first data table. The second partition key is different from the first partition key.

In this embodiment of the present disclosure, when the query instruction further includes the second query column and the second query condition, the second query column is the same as the second partition key, and an “and” relationship exists between the first query condition and the second query condition, for detailed descriptions of steps S201 and S203 to S205, refer to related descriptions and examples of steps S112 and S113 in the embodiment shown in FIG. 5. To avoid repetition, details are not described herein.

Optionally, in this embodiment of the present disclosure, when the first query column is the same as the first partition key in the first partition table, the query instruction further includes a second query column and a second query condition. The second query column is the same as the second partition key in the second partition table. An “or” relationship exists between the first query condition and the second query condition. The query instruction is further used to query data that is in the second partition table and that meets the second query condition. With reference to FIG. 7, as shown in FIG. 8, after step S201, the data table processing method provided in this embodiment of the present disclosure may further include the following steps.

Step S206. The primary server splits the query instruction into a first query instruction and a second query instruction.

The first query instruction includes the first query column and the first query condition. The second query instruction includes the second query column and the second query condition. The second partition table is obtained by partitioning the data in the second data table on the secondary server according to the second partition key. The second data table is the same as the first data table on the primary server. The second partition key is different from the first partition key.

Step S207. The primary server sends the second query instruction to the secondary server.

Step S208. The secondary server receives the second query instruction sent by the primary server.

Step S209. The secondary server executes the second query instruction on a second partition table.

As shown in FIG. 8, step S202 shown in FIG. 7 may further include step S202a.

Step S202a. The primary server executes the first query instruction on the first partition table.

In this embodiment of the present disclosure, when the query instruction further includes the second query column and the second query condition, the second query column is the same as the second partition key, and an “or” relationship exists between the first query condition and the second query condition, for detailed descriptions of steps S201 and S206 to S209, refer to related descriptions and examples of steps S114 to S119 in the embodiment shown in FIG. 6A and FIG. 6B. To avoid repetition, details are not described herein.

In this embodiment of the present disclosure, when a query instruction includes two query conditions (which may also be multiple query conditions in actual use), the primary server may determine, according to a relationship between the two query conditions, a specific physical machine (the primary server or the secondary server) for executing the query instruction. Therefore, based on a partition table obtained using the data table processing method provided in this embodiment of the present disclosure, query efficiency during a query of the partition table can be improved to some extent.

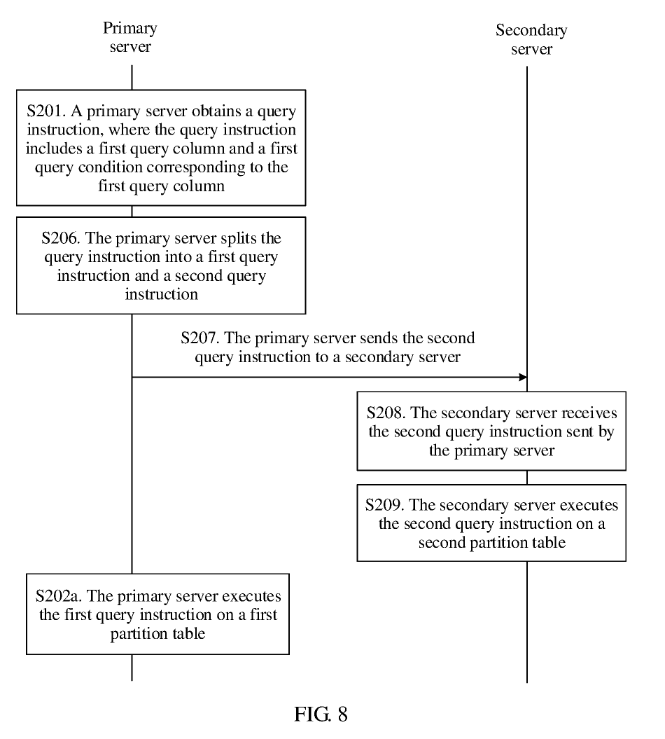

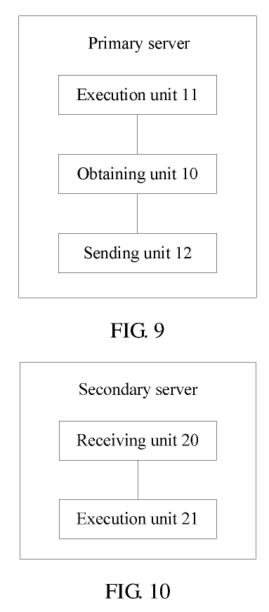

As shown in FIG. 9, an embodiment of the present disclosure provides a physical machine. The physical machine is a primary server in a database system cluster, the database system cluster includes the primary server and a secondary server, and the primary server includes an obtaining unit 10 configured to obtain a first partition instruction and a second partition instruction, where the first partition instruction includes a first partition key, the second partition instruction includes a second partition key, and the second partition key is different from the first partition key, an execution unit 11 configured to partition data in a first data table on the primary server according to the first partition instruction obtained by the obtaining unit 10 and the first partition key in order to obtain a first partition table, and a sending unit 12 configured to send the second partition instruction obtained by the obtaining unit 10 to the secondary server, where the second partition instruction is used to trigger the secondary server to partition data in a second data table on the secondary server according to the second partition key in order to obtain a second partition table, and the second data table is the same as the first data table.

Optionally, the obtaining unit 10 is further configured to obtain a query instruction. The query instruction includes a query column and a query condition. The query column is the same as the first partition key. The query instruction is used to query data that is in the first partition table and that meets the query condition. The execution unit 11 is further configured to execute the query instruction obtained by the obtaining unit 10 on the first partition table.

Optionally, the obtaining unit 10 is further configured to obtain a query instruction. The query instruction includes a query column and a query condition. The query column is the same as the second partition key. The query instruction is used to query data that is in the second partition table and that meets the query condition. The sending unit 12 is further configured to send the query instruction obtained by the obtaining unit 10 to the secondary server such that the secondary server executes the query instruction on the second partition table.

Optionally, the obtaining unit 10 is further configured to obtain a query instruction. The query instruction includes a first query column, a first query condition corresponding to the first query column, a second query column, and a second query condition corresponding to the second query column. The first query column is the same as the first partition key. The second query column is the same as the second partition key. An “and” relationship exists between the first query condition and the second query condition. The query instruction is used to query data that is in the first partition table and that meets the first query condition and the second query condition. The execution unit 11 is further configured to execute the query instruction obtained by the obtaining unit 10 on the first partition table.

Optionally, the obtaining unit 10 is further configured to obtain a query instruction. The query instruction includes a first query column, a first query condition corresponding to the first query column, a second query column, and a second query condition corresponding to the second query column. The first query column is the same as the first partition key. The second query column is the same as the second partition key. An “or” relationship exists between the first query condition and the second query condition. The query instruction is used to query data that is in the first partition table and that meets the first query condition, and query data that is in the second partition table and that meets the second query condition. The execution unit 11 is further configured to split the query instruction obtained by the obtaining unit 10 into a first query instruction and a second query instruction, where the first query instruction includes the first query column and the first query condition, and the second query instruction includes the second query column and the second query condition, and execute the first query instruction on the first partition table. The sending unit 12 is further configured to send, to the secondary server, the second query instruction obtained by means of splitting by the execution unit 11 such that the secondary server executes the second query instruction on the second partition table.

In this embodiment of the present disclosure, both the obtaining unit 10 and the execution unit 11 may be implemented using one or more processors, and the sending unit 12 may be implemented using an interface circuit. For example, the sending unit 12 may be further an interface circuit (which may further include a corresponding software interface if necessary) of the physical machine.

The physical machine provided in this embodiment of the present disclosure is the primary server in the database system cluster. The first data table on the primary server may be partitioned on the primary server according to the first partition key in order to obtain the first partition table. The second data table that is on the secondary server and is the same as the first data table is partitioned on the secondary server according to the second partition key different from the first partition key in order to obtain the second partition table. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

As shown in FIG. 10, an embodiment of the present disclosure provides a physical machine. The physical machine is a secondary server in a database system cluster, the database system cluster includes a primary server and the secondary server, and the secondary server includes a receiving unit 20 configured to receive a partition instruction sent by the primary server, where the partition instruction includes a partition key, and an execution unit 21 configured to partition data in a second data table on the secondary server according to the partition instruction in order to obtain a partition table, where the second data table is the same as a first data table on the primary server.

In this embodiment, the first data table is partitioned according to a partition key different from the partition key. The partition key by which the primary server partitions the first data table is referred to as a first partition key, and a partition table obtained after the primary server partitions the first data table is referred to as a first partition table. The partition key by which the secondary server partitions the second data table is referred to as a second partition key, and the partition table obtained after the secondary server partitions the second data table is referred to as a second partition table.

Optionally, the receiving unit 20 is further configured to receive a query instruction sent by the primary server. The query instruction includes a query column and a query condition. The query column is the same as the partition key. The query instruction is used to query data that is in the partition table and that meets the query condition. The execution unit 21 is further configured to execute the query instruction received by the receiving unit 20 on the partition table.

In this embodiment of the present disclosure, the execution unit 21 may be implemented using one or more processors, and the receiving unit 20 may be implemented using an interface circuit. For example, the receiving unit 20 may be further an interface circuit (which may further include a corresponding software interface if necessary) of the physical machine.

The physical machine provided in this embodiment of the present disclosure is the secondary server in the database system cluster. The second data table that is the same as the first data table on the primary server may be partitioned on the secondary server according to the second partition key different from the first partition key for partitioning the first data table on the primary server in order to obtain the second partition table different from the first partition table on the primary server. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

As shown in FIG. 11, an embodiment of the present disclosure provides a physical machine. The physical machine is a primary server in a database system cluster, the database system cluster includes the primary server and a secondary server, and the primary server includes an obtaining unit 30 configured to obtain a query instruction, where the query instruction includes a first query column and a first query condition corresponding to the first query column, and the query instruction is used to query data that is in a partition table and that meets the first query condition, an execution unit 31 configured to when the first query column is the same as a first partition key in a first partition table, execute the query instruction obtained by the obtaining unit 30 on the first partition table, where the first partition table is obtained by partitioning data in a first data table on the primary server according to the first partition key, and a sending unit 32 configured to when the first query column is the same as a second partition key in a second partition table, send the query instruction obtained by the obtaining unit 30 to the secondary server such that the secondary server executes the query instruction on the second partition table, where the second partition table is obtained by partitioning data in a second data table on the secondary server according to the second partition key, the second data table is the same as the first data table, and the second partition key is different from the first partition key.

Optionally, when the first query column is the same as the first partition key in the first partition table, the query instruction further includes a second query column and a second query condition. The second query column is the same as the second partition key in the second partition table. An “and” relationship exists between the first query condition and the second query condition. The query instruction is further used to query data that is in the first partition table and that meets the second query condition. The second partition table is obtained by partitioning the data in the second data table on the secondary server according to the second partition key. The second data table is the same as the first data table. The second partition key is different from the first partition key.

Optionally, when the first query column is the same as the first partition key in the first partition table, the query instruction further includes a second query column and a second query condition. The second query column is the same as the second partition key in the second partition table. An “or” relationship exists between the first query condition and the second query condition. The query instruction is further used to query data that is in the second partition table and that meets the second query condition.

The execution unit 31 is further configured to split the query instruction obtained by the obtaining unit 30 into a first query instruction and a second query instruction. The first query instruction includes the first query column and the first query condition. The second query instruction includes the second query column and the second query condition. The second partition table is obtained by partitioning the data in the second data table on the secondary server according to the second partition key. The second data table is the same as the first data table. The second partition key is different from the first partition key. The sending unit 32 is further configured to send, to the secondary server, the second query instruction obtained by means of splitting by the execution unit 31 such that the secondary server executes the second query instruction on the second partition table. The execution unit 31 is further configured to execute the first query instruction on the first partition table.

In this embodiment of the present disclosure, both the obtaining unit 30 and the execution unit 31 may be implemented using one or more processors, and the sending unit 32 may be implemented using an interface circuit. For example, the sending unit 32 may be further an interface circuit (which may further include a corresponding software interface if necessary) of the physical machine.

The physical machine provided in this embodiment of the present disclosure is the primary server in the database system cluster. The first partition table is obtained by partitioning the data in the first data table on the primary server according to the first partition key, and the second partition table is obtained by partitioning, according to the second partition key, the data in the second data table that is on the secondary server and is the same as the first data table. Therefore, when the first query column in the query instruction obtained by the primary server is the same as the first partition key, the primary server may execute the query instruction on the first partition table, or when the first query column in the query instruction obtained by the primary server is the same as the second partition key, the primary server may send the query instruction to the secondary server such that the secondary server executes the query instruction on the second partition table. A same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

As shown in FIG. 10, an embodiment of the present disclosure provides a physical machine. The physical machine is a secondary server in a database system cluster, the database system cluster includes a primary server and the secondary server, and the secondary server includes a receiving unit 20 configured to receive a query instruction sent by the primary server, where the query instruction includes a query column and a query condition, the query column is the same as a partition key in a partition table, the query instruction is used to query data that is in the partition table and that meets the query condition, the partition table is obtained by partitioning data in a second data table on the secondary server according to the partition key, and the second data table is the same as a first data table on the primary server, and an execution unit 21 configured to execute the query instruction received by the receiving unit 20 on the partition table.

In this embodiment of the present disclosure, the execution unit 21 may be implemented using one or more processors, and the receiving unit 20 may be implemented using an interface circuit. For example, the receiving unit 20 may be further an interface circuit (which may further include a corresponding software interface if necessary) of the physical machine.

The physical machine provided in this embodiment of the present disclosure is the secondary server in the database system cluster. The partition table is obtained by partitioning, according to the partition key, the data in the second data table that is on the secondary server and is the same as the first data table on the primary server. Therefore, when a query column in a query instruction obtained by the primary server is the same as the partition key, the primary server sends the query instruction to the secondary server such that the secondary server executes the query instruction on the partition table. Compared with the other approaches, in the data table processing method provided in this embodiment of the present disclosure, because the secondary server does not need to store multiple partition tables the same as partition tables stored in the primary server, a quantity of partition tables stored in the secondary server may be reduced such that storage space of the secondary server in the database system cluster can be saved, and data processing performance is improved, that is, data can be better managed.

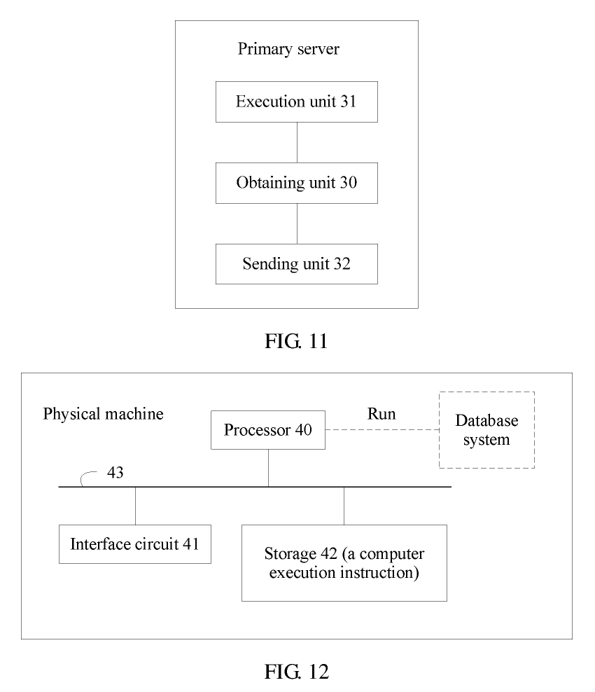

As shown in FIG. 12, an embodiment of the present disclosure provides a physical machine, and the physical machine includes a processor 40, an interface circuit 41, a storage 42, and a system bus 43.

The storage 42 is configured to store a computer execution instruction. The processor 40, the interface circuit 41, and the storage 42 are connected to each other using the system bus 43. When the physical machine runs, the processor 40 executes the computer execution instruction stored in the storage 42 such that the physical machine executes a data table processing method provided in an embodiment of the present disclosure.

In a first possible implementation, when the physical machine shown in FIG. 12 is the primary server shown in FIG. 9, the obtaining unit 10 and the execution unit 11 that are shown in FIG. 9 may be implemented using one or more processors 40 shown in FIG. 12, and the sending unit 12 shown in FIG. 9 may be implemented using the interface circuit 41 shown in FIG. 12.

In a second possible implementation, when the physical machine shown in FIG. 12 is the secondary server shown in FIG. 10, the execution unit 21 shown in FIG. 10 may be implemented using one or more processors 40 shown in FIG. 12, and the receiving unit 20 shown in FIG. 10 may be implemented using the interface circuit 41 shown in FIG. 12.

In a third possible implementation, when the physical machine shown in FIG. 12 is the primary server shown in FIG. 11, the obtaining unit 30 and the execution unit 31 that are shown in FIG. 11 may be implemented using one or more processors 40 shown in FIG. 12, and the sending unit 32 shown in FIG. 11 may be implemented using the interface circuit 41 shown in FIG. 12.

In a fourth possible implementation, when the physical machine shown in FIG. 12 is the secondary server shown in FIG. 10, the execution unit 21 shown in FIG. 10 may be implemented using one or more processors 40 shown in FIG. 12, and the receiving unit 20 shown in FIG. 10 may be implemented using the interface circuit 41 shown in FIG. 12.

In the first possible implementation and the second possible implementation, the physical machine shown in FIG. 12 executes the data table processing method shown in any one of FIG. 2 to FIG. 6A and FIG. 6B. In the third possible implementation and the fourth possible implementation, the physical machine shown in FIG. 12 executes the data table processing method shown in either FIG. 7 or FIG. 8. For details of the data table processing method shown in any one of FIG. 2 to FIG. 6A and FIG. 6B and details of the data table processing method shown in either FIG. 7 or FIG. 8, refer to related descriptions in the foregoing embodiments. To avoid repetition, details are not described herein again.

The processor 40 may be implemented using one or more processors. Only one processor is used as an example for description in FIG. 12. The processor 40 may be a Central Processing Unit (CPU). Alternatively, the processor 40 may be another general-purpose processor, a digital signal processor (DSP), an application-specific integrated circuit (ASIC), a field-programmable gate array (FPGA) or another programmable logic device, a discrete gate or a transistor logic device, a discrete hardware assembly, or the like. The general-purpose processor may be a microprocessor, or the processor 40 may be any conventional processor, or the like.

The interface circuit 41 may be a communications interface of the physical machine. The communications interface may be a wireless communications interface. For example, the wireless communications interface may be a wireless module of the physical machine, or the like. The processor 40 receives data from or sends data to another device such as another physical machine using the interface circuit 41.

The storage 42 may include a volatile memory, such as a random-access memory (RAM), or the storage 42 may include a non-volatile memory, such as a read-only memory (ROM), a flash memory, a hard disk drive, (HDD), or a solid-state drive (SSD), or the storage 42 may include a combination of the foregoing types of storages.

The storage 42 may include an underlying storage medium and a memory. The memory is coupled to the underlying storage medium, and is configured to be used as a cache of the underlying storage medium.

The system bus 43 may include a data bus, a power bus, a control bus, a status signal bus, or the like. In this embodiment, to clarify description, various buses in FIG. 12 are marked as the system bus 43.

Optionally, this embodiment further provides a readable storage medium. The readable storage medium includes a computer execution instruction. When the physical machine runs, the processor of the physical machine executes the computer execution instruction such that the physical machine executes the data table processing method that is shown in any one of FIG. 2 to FIG. 6A and FIG. 6B or in either FIG. 7 or FIG. 8 and is provided in the embodiments of the present disclosure.

Optionally, the readable storage medium in this embodiment of the present disclosure may be the storage 42 shown in FIG. 12.

The physical machine provided in this embodiment of the present disclosure is the primary server or the secondary server in a database system cluster, and is applied to the data table processing method shown in any one of FIG. 2 to FIG. 6A and FIG. 6B. A first data table on the primary server may be partitioned on the primary server according to a first partition key in order to obtain a first partition table. A second data table that is on the secondary server and is the same as the first data table is partitioned on the secondary server according to a second partition key different from the first partition key in order to obtain a second partition table. That is, a same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

The physical machine provided in this embodiment of the present disclosure is the primary server or the secondary server in a database system cluster, and is applied to the data table processing method shown in either FIG. 7 or FIG. 8. A first partition table is obtained by partitioning data in a first data table on the primary server according to a first partition key, and a second partition table is obtained by partitioning, according to a second partition key, data in a second data table that is on the secondary server and is the same as the first data table. Therefore, when a first query column in a query instruction obtained by the primary server is the same as the first partition key, the primary server may execute the query instruction on the first partition table, or when a first query column in a query instruction obtained by the primary server is the same as the second partition key, the primary server may send the query instruction to the secondary server such that the secondary server executes the query instruction on the second partition table. A same data table may be partitioned on the primary server and the secondary server according to different partition keys in order to obtain different partition tables. Therefore, compared with the other approaches, in the data table processing method provided in this embodiment of the present disclosure, because both the primary server and the secondary server do not need to store multiple same partition tables, a quantity of partition tables stored in the primary server and that of the secondary server may be reduced such that storage space of physical machines (including the primary server and the secondary server) in the database system cluster can be saved, and data processing performance is improved, that is, data can be better managed.

The foregoing descriptions about implementations allow a person skilled in the art to understand that, for a purpose of convenient and brief description, division of the foregoing functional modules is used as an example for description. In actual application, the foregoing functions can be allocated to different modules for implementation according to a requirement, that is, an inner structure of an apparatus is divided into different functional modules to implement all or some of the functions described above. For a detailed working process of the foregoing system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiment is only an example. For example, the module or unit division is only logical function division and may be other division in actual implementation. For example, multiple units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on multiple network units. Some or all of the units may be selected according to actual requirements to achieve the objectives of the solutions of the embodiments.

In addition, functional units in the embodiments of the present disclosure may be integrated into one processing unit, or each of the units may exist alone physically, or at least two units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of this application essentially, or the part contributing to the other approaches, or all or some of the technical solutions may be implemented in a form of a software product. The computer software product is stored in a storage medium and includes several instructions for instructing a computer device (which may be a personal computer, a server, a network device, or the like) or a processor to perform all or some of the steps of the methods described in the embodiments of the present disclosure. The storage medium includes any medium that can store program code, such as a universal serial bus (USB) flash drive, a removable hard disk, a ROM, a RAM, a magnetic disk, or an optical disc.

The foregoing descriptions are only specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A data table processing method, applied to a primary server in a database system cluster, the database system cluster comprising the primary server and a secondary server, and the processing method comprising:
obtaining, by the primary server, a first partition instruction and a second partition instruction, the first partition instruction comprising a first partition key, the second partition instruction comprising a second partition key, and the second partition key being different from the first partition key;
partitioning, by the primary server, data in a first data table on the primary server according to the first partition key to obtain a first partition table; and
sending, by the primary server, the second partition instruction to the secondary server, the second partition instruction triggering the secondary server to partition data in a second data table on the secondary server according to the second partition key to obtain a second partition table, and the second data table being the same as the first data table.

2. The processing method of claim 1, further comprising:
obtaining, by the primary server, a query instruction, the query instruction comprising a query column and a query condition, the query column being the same as the first partition key, and the query instruction querying data in the first partition table meeting the query condition; and
executing, by the primary server, the query instruction on the first partition table.

3. The processing method of claim 1, further comprising:
obtaining, by the primary server, a query instruction, the query instruction comprising a query column and a query condition, the query column being the same as the second partition key, and the query instruction querying data in the second partition table meeting the query condition; and
sending, by the primary server, the query instruction to the secondary server to enable the secondary server to execute the query instruction on the second partition table.

4. The processing method of claim 1, further comprising:
obtaining, by the primary server, a query instruction, the query instruction comprising a first query column, a first query condition corresponding to the first query column, a second query column, and a second query condition corresponding to the second query column, the first query column being the same as the first partition key, the second query column being the same as the second partition key, an “and” relationship existing between the first query condition and the second query condition, and the query instruction querying data in the first partition table meeting the first query condition and the second query condition; and
executing, by the primary server, the query instruction on the first partition table.

5. The processing method of claim 1, further comprising:
obtaining, by the primary server, a query instruction, the query instruction comprising a first query column, a first query condition corresponding to the first query column, a second query column, and a second query condition corresponding to the second query column, the first query column being the same as the first partition key, the second query column being the same as the second partition key, an “or” relationship existing between the first query condition and the second query condition, and the query instruction querying data in the first partition table meeting the first query condition and data in the second partition table meeting the second query condition;
splitting, by the primary server, the query instruction into a first query instruction and a second query instruction, the first query instruction comprising the first query column and the first query condition, and the second query instruction comprising the second query column and the second query condition;
executing, by the primary server, the first query instruction on the first partition table; and
sending, by the primary server, the second query instruction to the secondary server that to enable the secondary server to execute the second query instruction on the second partition table.

6. A physical machine, the physical machine being a primary server and comprising:
a bus;
a memory coupled to the bus and configured to store a program;
a communications interface coupled to the bus and configured to communicatively coupled to an external device; and
a processor coupled to the bus, the program stored in the memory causing the processor to be configured to:
obtain a first partition instruction and a second partition instruction, the first partition instruction comprising a first partition key, the second partition instruction comprising a second partition key, and the second partition key being different from the first partition key;
partition data in a first data table on the primary server according to the first partition key to obtain a first partition table; and
send the second partition instruction to a secondary server, the second partition instruction triggering the secondary server to partition data in a second data table on the secondary server according to the second partition key to obtain a second partition table, and the second data table is being the same as the first data table.

7. The physical machine of claim 6, wherein the program stored in the memory further causes the processor to be configured to:
obtain a query instruction, the query instruction comprising a query column and a query condition, the query column being the same as the first partition key, and the query instruction querying data in the first partition table meeting the query condition; and
execute the query instruction on the first partition table.

8. The physical machine of claim 6, wherein the program stored in the memory further causes the processor to be configured to:
obtain a query instruction, the query instruction comprising a query column and a query condition, the query column being the same as the second partition key, and the query instruction querying data in the second partition table meeting the query condition; and
send the query instruction to the secondary server to enable the secondary server to execute the query instruction on the second partition table.

9. The physical machine of claim 6, wherein the program stored in the memory further causes the processor to be configured to:
obtain a query instruction, the query instruction comprising a first query column, a first query condition corresponding to the first query column, a second query column, and a second query condition corresponding to the second query column, the first query column being the same as the first partition key, the second query column being the same as the second partition key, an “and” relationship existing between the first query condition and the second query condition, and the query instruction querying data in the first partition table meeting the first query condition and the second query condition; and
execute the query instruction on the first partition table.

10. The physical machine of claim 6, wherein the program stored in the memory further causes the processor to be configured to:
obtain a query instruction, the query instruction comprising a first query column, a first query condition corresponding to the first query column, a second query column, and a second query condition corresponding to the second query column, the first query column being the same as the first partition key, the second query column being the same as the second partition key, an “or” relationship existing between the first query condition and the second query condition, and the query instruction querying data in the first partition table and meeting the first query condition and data in the second partition table meeting the second query condition;
split the query instruction into a first query instruction and a second query instruction, the first query instruction comprising the first query column and the first query condition, and the second query instruction comprising the second query column and the second query condition;
execute the first query instruction on the first partition table; and
send the second query instruction to the secondary server to enable the secondary server to execute the second query instruction on the second partition table.

11. A non-transitory computer-readable storage medium storing computer instructions in which when executed by one or more processors, cause the one or more processors to be configured to:
obtain a first partition instruction and a second partition instruction, the first partition instruction comprising a first partition key, the second partition instruction comprising a second partition key, and the second partition key being different from the first partition key;
partition data in a first data table on a primary server according to the first partition key to obtain a first partition table; and
send the second partition instruction to a secondary server, the second partition instruction triggering the secondary server to partition data in a second data table on the secondary server according to the second partition key to obtain a second partition table, and the second data table being the same as the first data table.

12. The medium of claim 11, wherein the instructions further cause the one or more processors to be configured to:
obtain a query instruction, the query instruction comprising a query column and a query condition, the query column being the same as the first partition key, and the query instruction querying data in the first partition table meeting the query condition; and
execute the query instruction on the first partition table.

13. The medium of claim 11, wherein the instructions further cause the one or more processors to be configured to:
obtain a query instruction, the query instruction comprising a query column and a query condition, the query column being the same as the second partition key, and the query instruction querying data in the second partition table meeting the query condition; and
send the query instruction to the secondary server to enable the secondary server to execute the query instruction on the second partition table.

14. The medium of claim 11, wherein the instructions further cause the one or more processors to be configured to:
obtain a query instruction, the query instruction comprising a first query column, a first query condition corresponding to the first query column, a second query column, and a second query condition corresponding to the second query column, the first query column being the same as the first partition key, the second query column being the same as the second partition key, an “and” relationship existing between the first query condition and the second query condition, and the query instruction querying data in the first partition table meeting the first query condition and the second query condition; and
execute the query instruction on the first partition table.

15. The medium of claim 11, wherein the instructions further cause the one or more processors to be configured to:
obtain a query instruction, the query instruction comprising a first query column, a first query condition corresponding to the first query column, a second query column, and a second query condition corresponding to the second query column, the first query column being the same as the first partition key, the second query column being the same as the second partition key, an “or” relationship existing between the first query condition and the second query condition, and the query instruction querying data in the first partition table meeting the first query condition and data in the second partition table meeting the second query condition;
split the query instruction into a first query instruction and a second query instruction, the first query instruction comprising the first query column and the first query condition, and the second query instruction comprising the second query column and the second query condition;
execute the first query instruction on the first partition table; and
send the second query instruction to the secondary server to enable the secondary server to execute the second query instruction on the second partition table.
